(19) United States
(12) Patent Application Publication
(10) Pub. No.: US 2008/0214219 A1
(43) Pub. Date: Sep. 4, 2008

(54) STATUS COMMUNICATION SYSTEM, STATUS COMMUNICATION METHOD, STATUS COLLECTION TERMINAL, AND STORAGE MEDIUM STORING STATUS COLLECTION PROGRAM

(75) Inventor: Mika Matsushima, Inazawa-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/111,858

(22) Filed: Apr. 29, 2008

Related U.S. Application Data
(63) Continuation-in-part of application No. PCT/JP2006/321379, filed on Oct. 26, 2006.

(30) Foreign Application Priority Data
Nov. 1, 2005 (JP) 2005317958
Dec. 19, 2005 (JP) 2005364383

(51) Int. Cl. H04B 7/00

(52) U.S. Cl. 455/500

(57) ABSTRACT

A status communication system includes a plurality of first status communication terminals, a status collection terminal that communicates with the plurality of first status communication terminals, and a server that communicates with the status collection terminal via a network. Each of the plurality of the first status communication terminals includes at lease one measuring unit that measures biological data on a user and data on a user's peripheral environment, a first calculating unit that calculates first status data indicating one of status of the user and status of the peripheral environment based on measurement data measured by the measuring unit, and a first transmitting unit that transmits the first status data calculated by the first calculating unit. The status collection terminal includes a first collecting unit that collects the first status data transmitted from the first transmitting unit of at least one of the first status communication terminals, a second calculating unit that calculates second status data by consolidating the first status data collected by the first collecting unit under a prescribed condition, and a second transmitting unit that transmits the second status data calculated by the second calculating unit. The server includes a receiving unit that receives the second status data transmitted from the second transmitting unit of the status collection terminal, and a storing unit that stores the second status data received by the receiving unit.

### CROSS REFERENCE TO RELATED APPLICATION

This application claims priorities from Japanese Patent Application Nos. 2005-364383 filed Dec. 19, 2005, and 2005-317958 filed Nov. 1, 2005. This application is also a continuation-in-part of International Application No. PCT/JP2006/321379 filed Oct. 26, 2006 in Japan Patent Office as a Receiving Office. The contents of these applications are incorporated herein by reference.

### TECHNICAL FIELD

The present invention relates to a status communication system, a status communication method, a status collection terminal, and a storage medium storing a status collection program.

### BACKGROUND OF THE INVENTION

A conventional communication system for facilitating smooth communication between users, such as that proposed in Japanese patent application publication No. 2005-72743, is capable of transmitting changes in emotions and the like between users and updating such emotional changes in real-time. This communication system has terminals for updating information. Each terminal is provided with a detecting mechanism. The terminal determines the degree of joy, anger, sorrow, and pleasure at an information communication source based on emotional changes detected by the detecting mechanism and transmits the results of this determination to an information communication destination. The terminal at the information communication destination receiving these results includes a notifying mechanism for reporting the emotional changes at the information communication source to the user of the terminal at the information communication destination through images, sounds, vibrations, and the like.

However, when specifying a plurality of information communication terminals in this system from which information is to be transferred to or from, the number of connections required for connecting the terminals directly via a network becomes quite large. Consequently, the communication processing load on the terminals increases, leading to communication delays in some cases.

To resolve this problem, the inventor of the present invention proposed in Japanese patent application No. 2005-299561 a status communication system and status communication terminals capable of reducing the processing load for communications when transferring biological data on the user and data related to the ambient surroundings among a plurality of terminals. The status communication terminals described in Japanese patent application No. 2005-299561 communicate with an intermediary server to obtain data for all terminals including a specified terminal in order to render the status of the specified terminal. Hence, this system limits communications to that between each status communication terminal and the intermediary server, thereby reducing the communication load, even when a terminal is specified by a plurality of status communication terminals.

The inventor of the present invention also proposed in Japanese patent application No. 2005-220271 a status communication terminal and status communication terminal program for implementing communications between status communication terminals, without employing an intermediary server, in order to exchange biological data on the users and ambient data among a plurality of terminals. The terminals and program can convey data summarizing biological information on the users of the plurality of terminals and data summarizing environmental information to the user of each terminal.

### SUMMARY

However, since the status communication terminals in Japanese patent application No. 2005-220271 communicate directly with one another, there is a limitation on the scope of communications.

Therefore, it is an object of the present invention to provide a status communication system, status communication method, status collection terminal, and status collection program for facilitating the communication of data summarizing biological data and ambient environmental data for all users in a community formed of the users of a plurality of status communication terminals capable of communicating directly with one another.

To achieve the above and other objects, one aspect of the invention provides a status communication system including a plurality of first status communication terminals, a status collection terminal that communicates with the plurality of first status communication terminals, and a server that communicates with the status collection terminal via a network. Each of the plurality of the first status communication terminals includes at lease one measuring unit that measures biological data on a user and data on a user's peripheral environment, a first calculating unit that calculates first status data indicating one of status of the user and status of the peripheral environment based on measurement data measured by the measuring unit, and a first transmitting unit that transmits the first status data calculated by the first calculating unit. The status collection terminal includes a first collecting unit that collects the first status data transmitted from the first transmitting unit of at least one of the first status communication terminals, a second calculating unit that calculates second status data by consolidating the first status data collected by the first collecting unit under a prescribed condition, and a second transmitting unit that transmits the second status data calculated by the second calculating unit. The server includes a receiving unit that receives the second status data transmitted from the second transmitting unit of the status collection terminal, and a storing unit that stores the second status data received by the receiving unit.

In another aspect of the present invention, there is provided a status communication method performed in a status communication system including a plurality of first status communication terminals, a status collection terminal that communicates with the plurality of first status communication terminals, and a server that communicates with the status collection terminal via a network. The status communication method including:

on the first status communication terminal,

measuring one of biological data on a user and data on a user's peripheral environment;

calculating first status data indicating one of the status of the user and the status of the peripheral environment based on measurement data measured in the measuring step; and

transmitting the first status data calculated in the calculating step;

on the status collection terminal,

collecting the first status data transmitted in the transmitting step on the first status communication terminal performed by at least one first status communication terminal;

calculating second status data obtained by consolidating the first status data collected in the collecting step under a prescribed condition; and

transmitting the second status data calculated in the calculating step on the status collection terminal; and

on the server,

receiving the second status data transmitted in the transmitting step on the status collection terminal performed on the status collection terminal; and

storing the second status data received in the receiving step.

In another aspect of the present invention, there is provided a status collection terminal capable of communicating with a plurality of first status communication terminals that measures one of biological data on a user and data on a user's peripheral environment, calculates first status data indicating one of the status of the user and the user's peripheral environment based on the measurement data, and transmits the first status data to the status collection terminal, and capable of communicating with a server via a network. The status collection terminal includes a first collecting unit that collects the first status data transmitted from at least one of the first status communication terminals, a second calculating unit that calculates second status data by consolidating the first status data collected by the first collecting unit under a prescribed condition, and a second transmitting unit that transmits the second status data calculated by the second calculating unit to the server.

In another aspect of the present invention, there is provided a storage medium storing a status collection program readable by a computer. The status collection program controls a status collection terminal capable of communicating with a plurality of first status communication terminals that measures one of biological data on a user and data on the user's peripheral environment, calculates first status data indicating one of the status of the user and a user's peripheral environment based on the measurement data, and transmits the first status data to the status collection terminal, and capable of communicating with a server via a network. The status collection program includes:

instructions for collecting the first status data transmitted from at least one of the first status communication terminals;

instructions for calculating second status data by consolidating the first status data collected by the first collecting unit under a prescribed condition; and

instructions for transmitting the second status data calculated by the second calculating unit to the server.

### BRIEF DESCRIPTION OF THE DRAWINGS

In the drawings:

FIG. 1 is an explanatory diagram conceptually illustrating the structure of a status communication system according to a first embodiment of the present invention;

FIG. 2 is a front view of a status communication terminal in the status communication system of the first embodiment;

FIG. 3 is a block diagram showing the electrical structure of the status communication terminal in FIG. 2;

FIG. 4 is an explanatory diagram conceptually illustrating the structure of a storage area in RAM provided in the status communication terminal in FIG. 3;

FIG. 5 is an explanatory diagram conceptually illustrating the structure of a storage area in a hard disk (HD) provided in the status communication terminal in FIG. 3;

FIG. 6 is an explanatory diagram showing an inference table stored in the HD of FIG. 5;

FIG. 7 is a flowchart illustrating steps in a main process executed by a CPU of the data communication terminal according to the first embodiment;

FIG. 8 is a flowchart illustrating steps in a measurement process performed during the main process of FIG. 7;

FIG. 9 is a flowchart illustrating steps in an inference process performed during the main process of FIG. 7;

FIG. 10 is a flowchart illustrating steps in a heart rate classification process performed during the inference process of FIG. 9;

FIG. 11 is a flowchart illustrating steps in a body temperature classification process performed during the inference process of FIG. 9;

FIG. 12 is a flowchart illustrating steps in a perspiration classification process performed during the inference process of FIG. 9;

FIG. 13 is a perspective view of a status collection terminal according to the first embodiment of the present invention;

FIG. 14 is a block diagram showing the electrical structure of the status collection terminal in FIG. 13;

FIG. 15 is an explanatory diagram conceptually illustrating the structure of RAM in the status collection terminal in FIG. 14;

FIG. 16 is an explanatory diagram conceptually illustrating an all terminal data storage area of the RAM in FIG. 15;

FIG. 17 is a flowchart illustrating steps in a main process performed by a CPU of the status collection terminal according to the first embodiment;

FIG. 18 is a flowchart illustrating steps in a collection process performed during the main process of FIG. 17;

FIG. 19 is a flowchart illustrating steps in an internet communication process performed during the main process of FIG. 17;

FIG. 20 is a flowchart illustrating steps in a main process executed by a server of the status communication system according to the first embodiment;

FIG. 21 is a flowchart illustrating steps in a display unit control process performed during the main process of FIG. 17;

FIG. 22 is an explanatory diagram showing a display on a display unit in S503 of FIG. 21;

FIG. 23 is an explanatory diagram showing a display on a display unit in S509 of FIG. 21;

FIG. 24 is an explanatory diagram showing a display on a display unit in S512 of FIG. 21;

FIG. 25 is an explanatory diagram showing a display on a display unit in S516 of FIG. 21;

FIG. 26 is a front view of a second status communication terminal in the status communication system according to the first embodiment;

FIG. 27 is a block diagram showing the electrical structure of the second status communication terminal in FIG. 26;

FIG. 28 is an explanatory diagram conceptually illustrating the structure of a storage area in RAM of the second status communication terminal in FIG. 27;

FIG. 29 is an explanatory diagram conceptually illustrating the structure of a storage area in an HD of the second status communication terminal in FIG. 27;

FIG. 30 is a flowchart illustrating steps in a main process executed by a CPU of the second status communication terminal according to the first embodiment;

FIG. 31 is a block diagram showing the structure of a status communication system according to a second embodiment of the present invention;

FIG. 32 is an oblique top view of the status communication terminal in the status communication system according to the second embodiment;

FIG. 33 is a front view of the status communication terminal in FIG. 32;

FIG. 34 is a block diagram showing the electrical structure of the status communication terminal in FIG. 32;

FIG. 35 is an explanatory diagram conceptually illustrating the structure of a storage area in RAM of the status communication terminal in FIG. 34;

FIG. 36 is an explanatory diagram conceptually illustrating the structure of a sensing data storage area in the RAM of FIG. 35;

FIG. 37 is an explanatory diagram conceptually illustrating the structure of an own terminal data storage area in the RAM of FIG. 35;

FIG. 38 is an explanatory diagram conceptually illustrating the structure of an all terminal data storage area in the RAM of FIG. 35;

FIG. 39 is an explanatory diagram conceptually illustrating the structure of a status display table stored in the status display table storage area in the RAM of FIG. 35;

FIG. 40 is a flowchart illustrating steps in a main process executed with the status communication terminal according to the second embodiment;

FIG. 41 is a flowchart illustrating steps in an ID recognition process started during the main process of FIG. 40

FIG. 42 is a flowchart illustrating steps in a measurement process started during the process of FIG. 40;

FIG. 43 is a flowchart illustrating steps in a flag process executed during the measurement process of FIG. 42;

FIG. 44 is a flowchart illustrating steps in an emotion data detection process executed during the main process of FIG. 40;

FIG. 45 is a flowchart illustrating steps in an ambient data detection process executed during the main process of FIG. 40;

FIG. 46 is a flowchart illustrating steps in a data transmission/reception process executed during the main process of FIG. 40;

FIG. 47 is a flowchart illustrating steps in a specified terminal status display process executed during the main process of FIG. 40;

FIG. 48 is a block diagram showing the electrical structure of an intermediary server in the status communication system according to the second embodiment;

FIG. 49 is an explanatory diagram conceptually illustrating the structure of an all terminal data storage area on the intermediary server of FIG. 48;

FIG. 50 is a flowchart illustrating steps in a main process performed on the intermediary server according to the second embodiment; and

FIG. 51 is a time chart for the status communication system according to the second embodiment.

### DETAILED DESCRIPTION

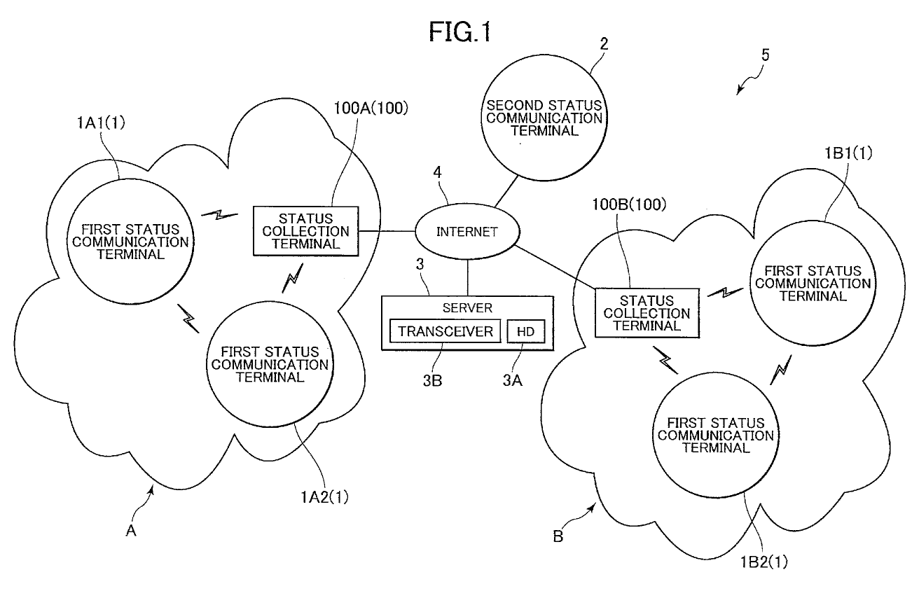

Hereinafter, a first embodiment of the present invention will be described while referring to the accompanying drawings. FIG. 1 is an explanatory diagram showing the overall structure of a status communication system 5 according to the first embodiment of the present invention.

As shown in FIG. 1, the status communication system 5 includes two status collection terminals 100 (a status collection terminal 100A and a status collection terminal 100B) and a second status communication terminal 2. The status collection terminals 100 and the second status communication terminal 2 are connected to the server 3 via an internet 4. A plurality of first status communication terminals 1 is disposed near each of the status collection terminals 100. Each of the status collection terminals 100 can communicate with the server 3 via the internet 4 and can communicate wirelessly with the plurality of first status communication terminals 1 disposed in the vicinity of the status collection terminal 100. Since the range of wireless communications between the status collection terminals 100 and first status communication terminals 1 is limited, each status collection terminal 100 can communicate only with the first status communication terminals 1 positioned within this range.

While the status communication system 5 shown in FIG. 1 has two status collection terminals 100, one second status communication terminal 2, and four first status communication terminals 1, the actual number of these devices is not limited to that shown in FIG. 1.

Next, a brief overview of the status communication system 5 will be given. A “community” is formed of users using the first status communication terminals 1 disposed within communication range of the status collection terminal 100.

In the example shown in FIG. 1, a community A is formed of a user A1 and a user A2 using respectively a first status communication terminal 1A1 and a first status communication terminal 1A2 disposed within communication range of the status collection terminal 100A. Similarly, a community B is formed of a user B1 and a user B2 using a first status communication terminal 1B1 and a first status communication terminal 1B2 disposed within communication range of the status collection terminal 100B. A user C also exists for the second status communication terminal 2.

The users of all first status communication terminals 1 disposed near the status collection terminal 100 will be referred to as the users of the status collection terminal 100 in the following description. For example, users of the status collection terminal 100A include the users A1 and A2.

A sequential number is assigned to each terminal as an ID number. For example, the ID number 1 is assigned to the first status communication terminal 1A1, 2 to the first status communication terminal 1A2, 3 to the status collection terminal 100A, 4 to the first status communication terminal 1B1, 5 to the first status communication terminal 1B2, 6 to the status collection terminal 100B, and 7 to the second status communication terminal 2.

As will be described later, both the first status communication terminals 1 and the second status communication terminal 2 are provided with sensors for measuring biological data on each user of the terminals. Each terminal infers a state of the user (such as “excited,” “depressed,” or “sleepy”) based on measured values from the sensors, and computes a value corresponding to this state. In the following description, the state of a user calculated by the first status communication terminals 1 and second status communication terminal 2 is referred to as first status data.

The status collection terminal 100 collects the first status data from the plurality of first status communication terminals 1 disposed in the vicinity thereof. The status collection terminal 100 then calculates values corresponding to the states of all users of terminals in the vicinity thereof based on the collected first status data. This calculated values are referred to as second status data.

For example, the status collection terminal 100A collects first status data from the first status communication terminal 1A1 and first status communication terminal 1A2 and calculates second status data for the users A1 and A2 based on the first status data.

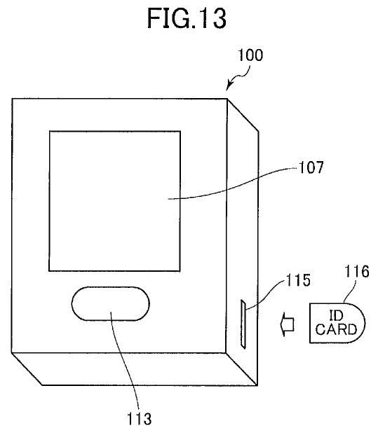

The status collection terminal 100 has a display unit 107 (see FIG. 13) for displaying desired images. The status collection terminal 100 modifies the color of the display unit 107 based on the values of the calculated second status data. Hence, the status of all users of the status collection terminal 100 can be confirmed visually on the status collection terminal 100.

The status collection terminal 100 and the second status communication terminal 2 can also specify users of other terminals, such as the first status communication terminals 1, second status communication terminal 2, and the status collection terminals 100 (100A and 100B), when a user desires to know the status of these users.

As will be described later, a slot 115 (see FIGS. 13 and 26) is formed in the status collection terminals 100 and the second status communication terminal 2. An ID card 116 storing data for another terminal that the user wishes to specify is inserted into the slot 115. The status collection terminal 100 can acquire a value from the server 3 indicating the status of the user of the terminal specified on the ID card 116 and can display the status of this user.

The status collection terminal 100 can also calculate third status data indicating the status of all users, including the user of the terminal specified on the ID card 116 and the user of the status collection terminal 100 itself. The third status data is calculated based on a value indicating the state of the user of the terminal specified on the ID card 116 and a value for the second status data indicating the state of the user using the status collection terminal 100 itself. The status collection terminal 100 can display colors corresponding to the third status data on the display unit 107.

Accordingly, the user of the status collection terminal 100 can visually check the status for users of other terminals (“excited,” “depressed,” or “sleepy”). In this way, the status communication system 5 achieves smooth communication among users or among communities. This will be described in greater detail below.

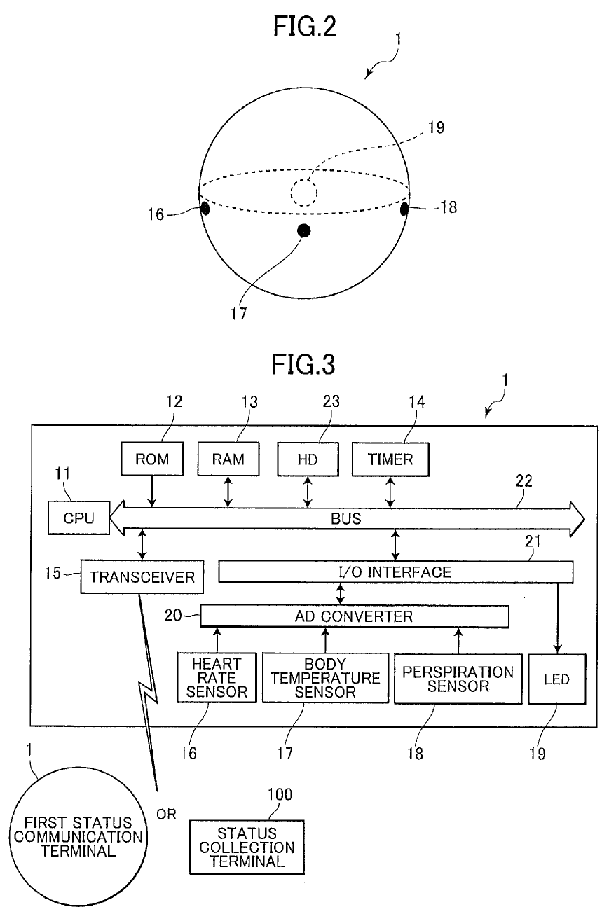

First, the first status communication terminal 1 will be described in greater detail. FIG. 2 is a front view of the first status communication terminal 1. FIG. 3 is a block diagram showing the electrical structure of the first status communication terminal 1.

As shown in FIG. 2, the first status communication terminal 1 is substantially spherical in shape and of a size appropriate for the user to grip with one or two hands. The outer casing of the first status communication terminal 1 is formed of a transparent synthetic resin in a spherical shape and at a thickness of several millimeters (5 mm, for example). The interior space defined by the outer casing is also spherical in shape and hermetically sealed.

A disc-shaped circuit board is disposed inside the casing of the first status communication terminal 1 in a plane that passes through the center of the casing and is parallel to the surface on which the bottom of the casing rests. The circuit board is connected to various sensors 16-18, an LED 19, a CPU 11, a ROM 12, a RAM 13, and the like (see FIG. 3).

As shown in FIG. 3, the CPU 11 is provided inside the casing of the first status communication terminal 1 for controlling the first status communication terminal 1. The CPU 11 is connected, via a bus 22, to the ROM 12 for storing control programs and the like, the RAM 13 for temporarily storing various data, a hard disk (HD) 23 for storing various data, a timer 14 for measuring elapsed time, a transceiver 15 for communicating with another first status communication terminal 1 or the status collection terminal 100, and an I/O interface 21 for connecting various modules. Power is supplied to the first status communication terminal 1 via a battery (not shown).

The first status communication terminal 1 also includes an AD converter 20 connected to the sensors 16-18. The AD converter 20 is also connected to the CPU 11 via the I/O interface 21 and bus 22. The AD converter 20 converts analog measurement values inputted from the sensors 16-18 to digital data and transfers this data to the CPU 11.

Next, the sensors 16-18 will be described. Various sensors are provided for measuring biological data on the person using the first status communication terminal 1. In the preferred embodiment, the sensors include a heart rate sensor 16, a body temperature sensor 17, and a perspiration sensor 18 for measuring the heart rate, body temperature, and perspiration of the user. The sensors 16-18 are disposed on the surface of the first status communication terminal 1. The heart rate sensor 16 is an infrared sensor for measuring the heart rate (pulse rate) of the person touching the first status communication terminal 1 or peripheral motion when the user is not touching the first status communication terminal 1. The body temperature sensor 17 is a temperature indicator employing a platinum resistance temperature detector, a thermistor, a thermocouple, or the like for measuring the ambient temperature of the first status communication terminal 1 and the temperature of the user's fingers or palms touching the first status communication terminal 1. The perspiration sensor 18 is a small humidity sensor for measuring perspiration on the surface of the first status communication terminal 1 by measuring evaporated moisture. The perspiration sensor 18 employs mg/cm²/min as the measurement units, measuring the amount of perspiration in 1 cm²/min. Hence, when the user grips the first status communication terminal 1 so that the user's fingers or palms touch the sensors, the first status communication terminal 1 can accurately measure the user's heart rate, body temperature, and perspiration. As will be described later, the first status communication terminal 1 infers the state of individual users of the first status communication terminal 1 (“excited,” “depressed,” or “sleepy,” for example) based on measured values of these sensors.

The LED 19 can light in various colors (green, blue, and red) and at various brightnesses and can emit light in desired directions (upward, downward, and the like). In this way, the LED 19 can express each state of a user by the emitted color. For example, the LED 19 emits red light to express an excited state, blue light to express a depressed state, and green light to express a sleepy state. Therefore, the user of the first status communication terminal 1 can visually determine the user's own current state or the current states of others.

The LED 19 is connected to the CPU 11 via the I/O interface 21 and bus 22. The CPU 11 outputs instruction signals that are inputted into the LED 19 via the I/O interface 21 and bus 22.

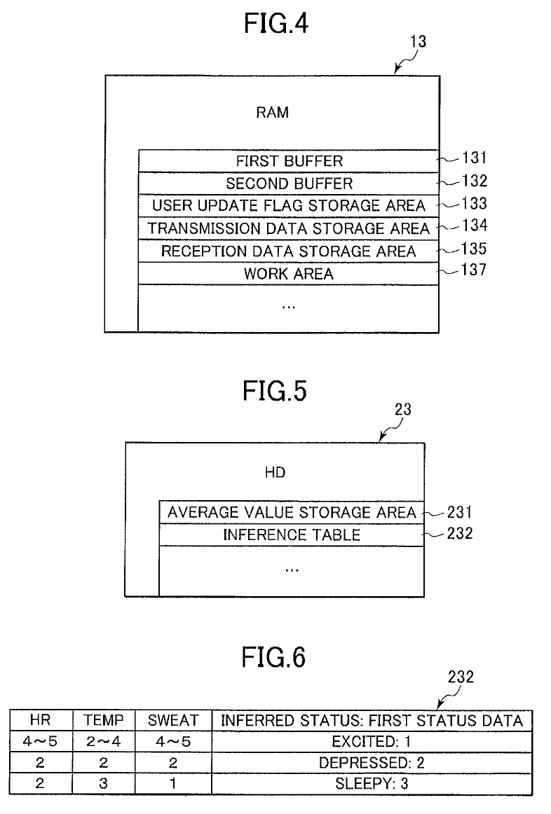

Next, the structure of a storage area in the RAM 13 will be described. FIG. 4 is an explanatory diagram illustrating the configuration of this storage area.

The RAM 13 is provided with a first buffer 131, a second buffer 132, a user update flag storage area 133, a transmission data storage area 134, a reception data storage area 135, and a work area 137.

The first buffer 131 and second buffer 132 temporarily store values measured by the sensors 16-18. The user update flag storage area 133 stores the state of a user update flag described later. The transmission data storage area 134 stores the first status data inferred in an inference process described later. The reception data storage area 135 stores data received from the status collection terminal 100. The work area 137 is used when the CPU 11 executes various processes.

Next, the structure of a storage area in the HD 23 will be described. FIG. 5 is an explanatory diagram showing the structure of the storage area.

As shown in FIG. 5, the HD 23 includes an average value storage area 231, and an inference table 232. The average value storage area 231 stores average values of the user's body temperature, heart rate, and perspiration. Average values for the user's body temperature and the like may be values acquired from an external database, or may be continuously updated based on values measured each time the first status communication terminal 1 is used.

The inference table 232 is used in the inference process described later when calculating the first status data based on values measured by the sensors 16-18.

FIG. 6 shows an example of the inference table 232. The inference table 232 stores values found in the inference process for variables HR, TEMP, and SWEAT, and the status of users corresponding to the variable values.

The variable TEMP is set based on the measured value from the body temperature sensor 17 and the average body temperature value stored in the average value storage area 231. The variable HR is set based on the measured value of the heart rate sensor 16 and the average heart rate value stored in the average value storage area 231.

The variable SWEAT is set based on the measured value from the perspiration sensor 18 and the average perspiration value stored in the average value storage area 231.

In the preferred embodiment, states inferred for users include “excited,” “depressed,” “sleepy,” and “normal.” The inference table 232 shown in FIG. 6 stores values of the variables TEMP, HR, and SWEAT corresponding the states “excited,” “depressed,” and “sleepy” respectively in association with each other.

For example, the inference table 232 shown in FIG. 6 stores “excited” for the case when the variable HR is 4-5, the variable TEMP is 2-4, and the variable SWEAT is 4-5; “depressed” for the case when the variable HR is 2, the variable TEMP is 2, and the variable SWEAT is 2; and “sleepy” for the case when the variable HR is 2, the variable TEMP is 3, and the variable SWEAT is 1. In the inference process, the state “normal” is inferred when the combination of variable values does not correspond to any of the combinations in FIG. 6. Hence, “normal” is not included in the inference table 232.

The first status data functioning to identify these states is set to 1 for “excited,” 2 for “depressed,” 3 for “sleepy,” and 0 for “normal.”

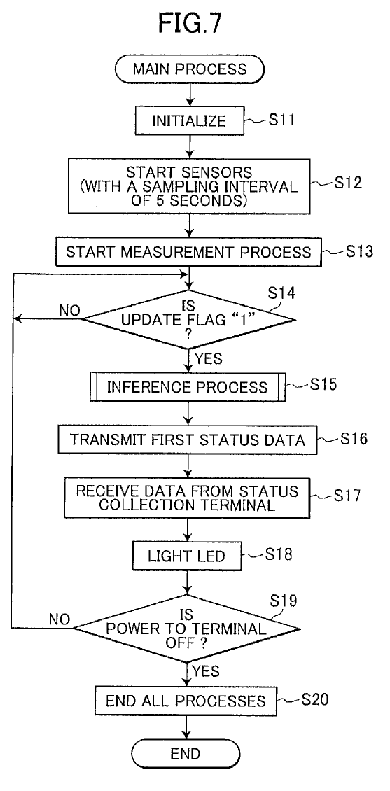

Next, the operations of the first status communication terminal 1 will be described. FIG. 7 is a flowchart illustrating steps in a main process executed by the CPU 11 of the first status communication terminal 1.

The main process begins when the power to the first status communication terminal 1 is turned on. In S11 at the beginning of the main process, the CPU 11 initializes each region in the RAM 13.

In S12 the CPU 11 activates the sensors 16-18 and begins to sample measured values from the sensors at five-second intervals. For example, one second after the heart rate sensor 16 measures the heart rate of the user, the body temperature sensor 17 measures the body temperature of the user. One second after the body temperature sensor 17 measures the body temperature of the user, the perspiration sensor 18 measures the perspiration of the user. Three seconds after the perspiration sensor 18 measures the perspiration of the user, the heart rate sensor 16 again measures the heart rate of the user. In this way, the sensors 16-18 repeatedly take measurements in sequence. After taking each measurement, the sensors 16-18 transmit the measured values to the CPU 11.

In S13, the CPU 11 initiates a measurement process and starts performing the measurement process separately from the main process. The measurement process will be described later.

After initiating the measurement process, in S14 the CPU 11 determines whether a user update flag is set to 1. If the user update flag is not set to 1 (S14: NO), then the CPU 11 continues to loop back to S14 until determining that the user update flag has been set to 1.

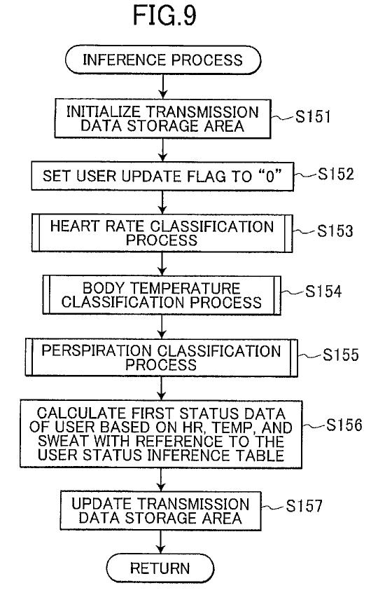

When the user update flag is set to 1 (S14: YES), in S15 the CPU 11 executes the inference process. In the inference process, the CPU 11 infers the state of the user based on measurement values from the sensors 16-18 stored in the second buffer 132 and stores this status in the transmission data storage area 134 as the first status data. The inference process will be described later in greater detail with reference to FIG. 9.

After storing the first status data in the transmission data storage area 134 in the inference process, in S16 the CPU 11 transmits the first status data from the transmission data storage area 134 to other terminals within wireless communication range of the first status communication terminal 1 transferring the first status data (for example, the first status communication terminal 1A2 and the status collection terminal 100A in the preferred embodiment when the first status communication terminal 1A1 transmits the data). As will be described later, after receiving first status data from the first status communication terminal 1, the status collection terminal 100 transmits first status data inferred by the second status communication terminal 2, second status data inferred by other status collection terminals 100, or third status data calculated by the status collection terminal 100 to the first status communication terminal 1.

After transmitting the first status data in S16, in S17 the CPU 11 receives the first status data inferred by the second status communication terminal 2 or the second status data or third status data from the status collection terminal 100 and stores this data in the reception data storage area 135.

In S18 the CPU 11 controls the LED 19 to emit light of colors corresponding to the first status data stored in the transmission data storage area 134 and the data stored in the reception data storage area 135.

As described above, the LED 19 can emit light in specified directions. Accordingly, light of the color corresponding to the first status data stored in the transmission data storage area 134 appears in the lower section of the first status communication terminal 1, while light of the color corresponding to data stored in the reception data storage area 135 appears in the upper section of the first status communication terminal 1.

If the data stored in the transmission data storage area 134 or the reception data storage area 135 has a value of 1, indicating the excited state, the LED 19 is lit in red. If the data stored in the transmission data storage area 134 or the reception data storage area 135 has a value of 2, indicating the depressed state, the LED 19 is lit in blue. If the data stored in the transmission data storage area 134 or the reception data storage area 135 has a value of 3, indicating the sleepy state, the LED 19 is lit in green. If the data stored in the transmission data storage area 134 or the reception data storage area 135 has a value of 0, indicating the normal state, the LED 19 is not lit.

Hence, the user of the first status communication terminal 1 can visually determine the user's own current state or the current states of others.

After lighting the LED 19 in S18, in S19 the CPU 11 determines whether a power button (not shown) has been operated to turn off the power.

If the power has not been turned off (S19: NO), the CPU 11 returns to S14 and repeats the process of S14-S19.

However, if the power has been turned off (S19: YES), then in S20 the CPU 11 ends all processes and turns off the power.

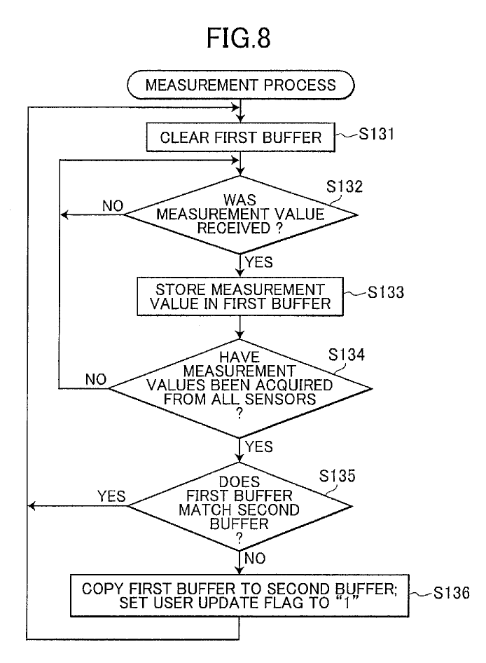

Next, the measurement process will be described. After initiating the measurement process in S13 of the main process (FIG. 7), the CPU 11 begins the measurement process separately from the main process. FIG. 8 is a flowchart illustrating steps in the measurement process.

In S131 at the beginning of the measurement process, the CPU 11 clears the first buffer 131. In S132 the CPU 11 determines whether measurement values have been received from any of the sensors 16-18. If no measurement values have been received (S132: NO), the CPU 11 continually loops back to S132 until a measurement value has been received.

When a measurement value has been received (S132: YES), in S133 the CPU 11 stores the received value in the first buffer 131.

In S134 the CPU 11 determines whether measurement values have been acquired from all of the sensors 16-18. If measurement values have not been acquired from all sensors (S134: NO), the CPU 11 returns to S132.

When measurement values have been acquired from all sensors (S134: YES), in S135 the CPU 11 determines whether the values in the first buffer 131 match the values in the second buffer 132.

If the values stored in the first buffer 131 and second buffer 132 match (S135: YES), the CPU 11 returns to S131.

If the values stored in the first buffer 131 and second buffer 132 do not match (S135: NO), then in S136 the CPU 11 copies the values in the first buffer 131 to the second buffer 132 and sets the user update flag to 1. Subsequently, the CPU 11 returns to S131 and repeats the process of S131-S136 described above.

Next, the inference process performed in S15 of the main process (FIG. 7) will be described. FIG. 9 is a flowchart illustrating steps in the inference process.

The CPU 11 initiates the inference process of S15 upon determining in S14 of the main process that the user update flag has been set to 1 (S14: YES). In S151 at the beginning of the inference process, the CPU 11 initializes the transmission data storage area 134. Initialization in this case is accomplished by erasing all data stored in the transmission data storage area 134 of the RAM 13.

In S152 the CPU 11 resets the user update flag stored in the user update flag storage area 133 to 0. In S153 the CPU 11 performs a heart rate classification process to set the variable HR.

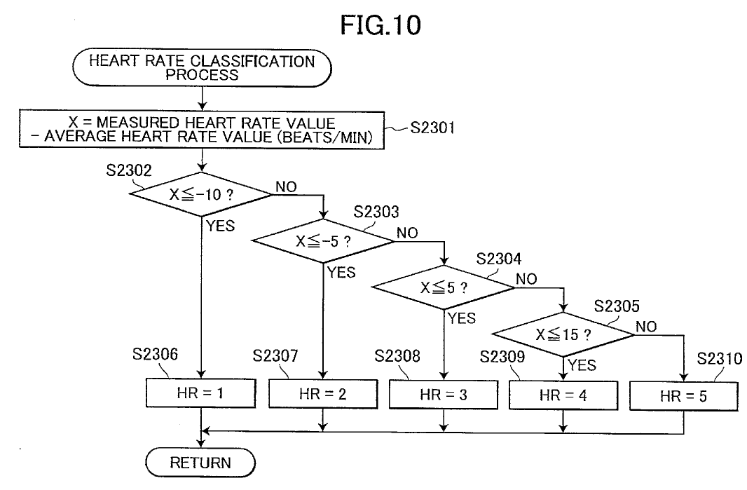

The heart rate classification process of S153 will be described here. FIG. 10 is a flowchart illustrating steps in the heart rate classification process. The CPU 11 begins the heart rate classification process of S153 after setting the user update flag to 0 in S152.

In S2301 at the beginning of the heart rate classification process, the CPU 11 subtracts the average heart rate value stored in the average value storage area 231 from the measured heart rate value (measured value from the heart rate sensor 16) stored in the second buffer 132 to calculate a heart rate difference X.

In S2302 the CPU 11 determines whether the heart rate difference X is no greater than −10. The value −10 has been set arbitrarily. If the heart rate difference X is no greater than −10 (S2302: YES), then in S2306 the CPU 11 sets the variable HR to 1, ends the heart rate classification process, and returns to the inference process in FIG. 9. However, if the heart rate difference X is greater than −10 (S2302: NO), then in S2303 the CPU 11 determines whether the heart rate difference X is no greater than −5.

If the heart rate difference X is no greater than −5 (S2303: YES), then in S2307 the CPU 11 sets the variable HR to 2, ends the heart rate classification process, and returns to the inference process. However, if the heart rate difference X is greater than −5 (S2303: NO), then in S2304 the CPU 11 determines whether the heart rate difference X is no greater than 5.

If the heart rate difference X is no greater than 5 (S2304: YES), then in S2308 the CPU 11 sets the variable HR to 3, ends the heart rate classification process, and returns to the inference process. However, if the heart rate difference X is greater than 5 (S2304: NO), then in S2305 the CPU 11 determines whether the heart rate difference X is no greater than 15.

If the heart rate difference X is no greater than 15 (S2305: YES), then in S2309 the CPU 11 sets the variable HR to 4, ends the heart rate classification process, and returns to the inference process. However, if the heart rate difference X is greater than 15 (S2305: NO), then in S2310 the CPU 11 sets the variable HR to 5, ends the heart rate classification process, and returns to the inference process.

After setting the variable HR in the heart rate classification process described above, in S154 the CPU 11 sets the variable TEMP in a body temperature classification process.

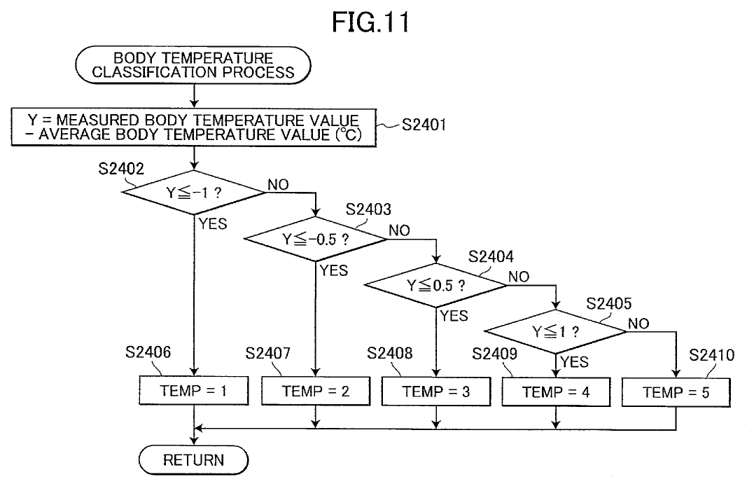

The body temperature classification process of S154 will be described here. FIG. 11 is a flowchart illustrating steps in this body temperature classification process. The CPU 11 begins the body temperature classification process of S154 after completing the heart rate classification process in S153.

In S2401 at the beginning of the body temperature classification process, the CPU 11 subtracts the average body temperature value stored in the average value storage area 231 from the measured body temperature value (measured value from the body temperature sensor 17) stored in the second buffer 132 to calculate a body temperature difference Y.

In S2402 the CPU 11 determines whether the body temperature difference Y is no greater than −1. If the body temperature difference Y is no greater than −1 (S2402: YES), then in S2406 the CPU 11 sets the variable TEMP to 1, ends the body temperature classification process, and returns to the inference process. However, if the body temperature difference Y is greater than −1 (S2402: NO), then in S2403 the CPU 11 determines whether the body temperature difference Y is no greater than −0.5.

If the body temperature difference Y is no greater than −0.5 (S2403: YES), then in S2407 the CPU 11 sets the variable TEMP to 2, ends the body temperature classification process, and returns to the inference process. However, if the body temperature difference Y is greater than −0.5 (S2403: NO), then in S2404 the CPU 11 determines whether the body temperature difference Y is no greater than 0.5.

If the body temperature difference Y is no greater than 0.5 (S2404: YES), then in S2408 the CPU 11 sets the variable TEMP to 3, ends the body temperature classification process, and returns to the inference process. However, if the body temperature difference Y is greater than 0.5 (S2404: NO), then in S2405 the CPU 11 determines whether the body temperature difference Y is no greater than 1.

If the body temperature difference Y is no greater than 1 (S2405: YES), then in S2409 the CPU 11 sets the variable TEMP to 4, ends the body temperature classification process, and returns to the inference process. However, if the body temperature difference Y is greater than 1 (S2405: NO), then in S2410 the CPU 11 sets the variable TEMP to 5, ends the body temperature classification process, and returns to the inference process.

After setting the variable TEMP in the body temperature classification process described above, in S155 the CPU 11 sets the variable SWEAT through the perspiration classification process.

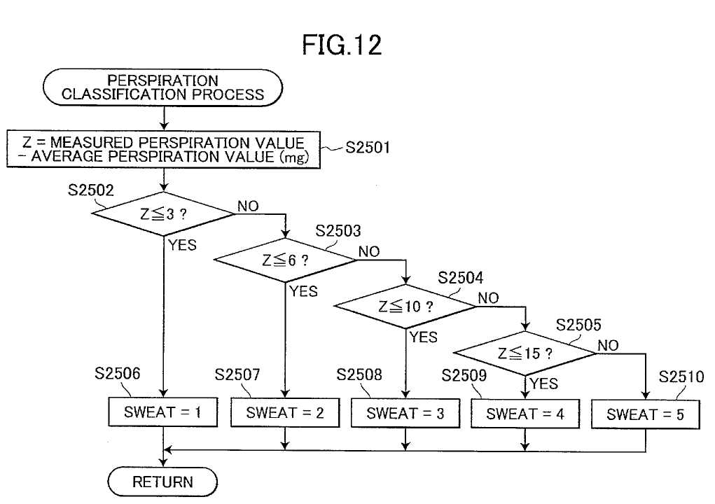

The perspiration classification process of S155 will be described next. FIG. 12 is a flowchart illustrating steps in this perspiration classification process. The CPU 11 begins the perspiration classification process of S155 after completing the body temperature classification process in S154 of the inference process.

In S2501 at the beginning of the perspiration classification process, the CPU 11 subtracts the average perspiration value stored in the average value storage area 231 from the measured perspiration value (measured value from the perspiration sensor 18) stored in the second buffer 132 to calculate a perspiration difference Z.

In S2502 the CPU 11 determines whether the perspiration difference Z is no greater than 3. If the perspiration difference Z is no greater than 3 (S2502: YES), then in S2506 the CPU 11 sets the variable SWEAT to 1, ends the perspiration classification process, and returns to the inference process. However, if the perspiration difference Z is greater than 3 (S2502: NO), then in S2503 the CPU 11 determines whether the perspiration difference Z is no greater than 6.

If the perspiration difference Z is no greater than 6 (S2503: YES), then in S2507 the CPU 11 sets the variable SWEAT to 2, ends the perspiration classification process, and returns to the inference process. However, if the perspiration difference Z is greater than 6 (S2503: NO), then in S2504 the CPU 11 determines whether the perspiration difference Z is no greater than 10.

If the perspiration difference Z is no greater than 10 (S2504: YES), then in S2508 the CPU 11 sets the variable SWEAT to 3, ends the perspiration classification process, and returns to the inference process. However, if the perspiration difference Z is greater than 10 (S2504: NO), then in S2505 the CPU 11 determines whether the perspiration difference Z is no greater than 15.

If the perspiration difference Z is no greater than 15 (S2505: YES), then in S2509 the CPU 11 sets the variable SWEAT to 4, ends the perspiration classification process, and returns to the inference process. However, if the perspiration difference Z is greater than 15 (S2505: NO), then in S2510 the CPU 11 sets the variable SWEAT to 5, ends the perspiration classification process, and returns to the inference process.

After completing the perspiration classification process of S155, in S156 the CPU 11 calculates a value for the first status data based on the three variables HR, TEMP, and SWEAT set in S153-S155 and the inference table 232 stored on the HD 23.

More specifically, the CPU 11 sets the first status data to the value 1 when the variable HR is 4-5, the variable TEMP is 2-4, and the variable SWEAT is 4-5; sets the first status data to the value 2 when the variable HR is 2, the variable TEMP is 2, and the variable SWEAT is 2; and sets the first status data to the value 3 when the variable HR is 2, the variable TEMP is 3, and the variable SWEAT is 1. If the combination of values for the three variables does not match any of the combinations given above, the CPU 11 sets the first status data to the value 0.

In S157 the CPU 11 stores the first status data calculated as above in the transmission data storage area 134 and returns to the main process.

Next, the status collection terminal 100 will be described in greater detail. FIG. 13 is a perspective view of the status collection terminal 100. As shown in FIG. 13, the status collection terminal 100 has a box-shaped casing on the front surface of which are provided the rectangular display unit 107, and a membrane switch 113. The display unit 107 and the membrane switch 113 are arranged in the same plane and separated at a prescribed distance vertically.

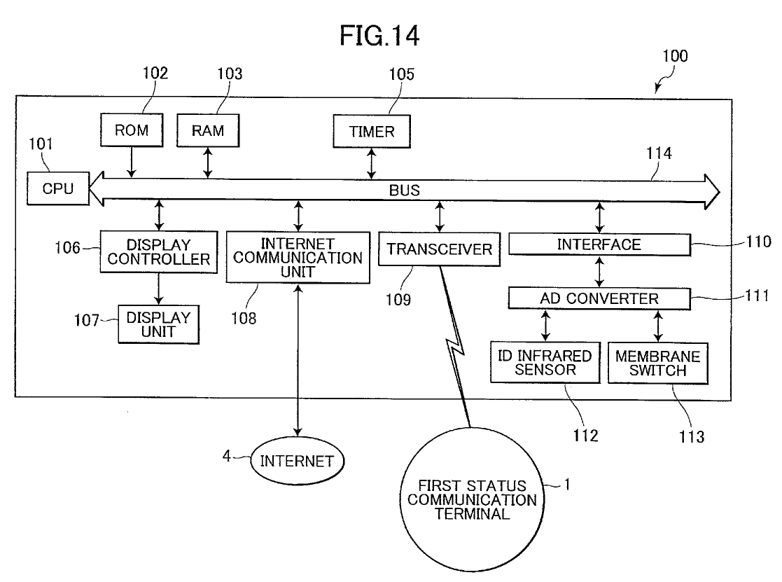

The slot 115 is formed in the side surface of the status collection terminal 100 for accepting the ID card 116 inserted therein. When the ID card 116 is inserted into the slot 115, an ID infrared sensor 112 (see FIG. 14) reads an ID stored on the ID card 116.

FIG. 14 is a block diagram showing the electrical structure of the status collection terminal 100. As shown in FIG. 14, a CPU 101 is built into the status collection terminal 100 for controlling operations of the same. The CPU 101 is connected via a bus 114 to a ROM 102, a RAM 103, a timer 105, a display controller 106, an internet communication unit 108, a transceiver 109, and an interface 110.

The ROM 102 stores control programs for the status collection terminal 100 executed by the CPU 101. The RAM 103 temporarily stores data used in various processes described later. The timer 105 measures elapsed time. The internet communication unit 108 communicates with the internet 4 based on instructions from the CPU 101. The transceiver 109 communicates with first status communication terminals 1 within wireless communication range based on instructions from the CPU 101.

The display controller 106 is connected to the display unit 107 and controls the display on the display unit 107 based on instructions from the CPU 101. The interface 110 is connected to the ID infrared sensor 112 and membrane switch 113 via an AD converter 111. The AD converter 111 functions to convert analog input signals from the ID infrared sensor 112 and membrane switch 113 to digital signals and to transfer these digital signals to the CPU 101 via the interface 110.

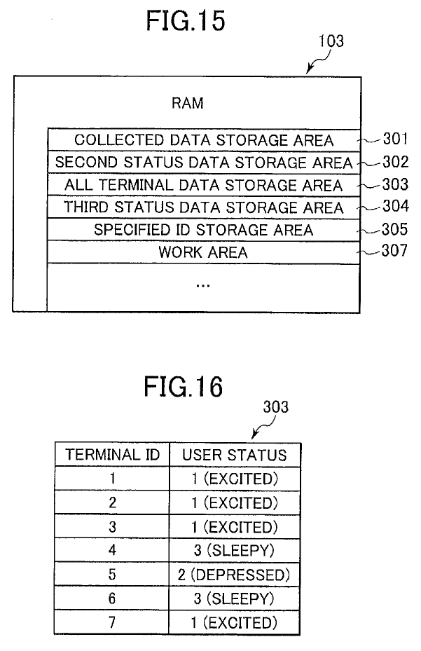

The structure of the storage area in the RAM 103 will be described next. FIG. 15 is an explanatory diagram showing the structure of the RAM 103. As shown in FIG. 15, the RAM 103 is provided with a collected data storage area 301, a second status data storage area 302, an all terminal data storage area 303, a third status data storage area 304, a specified ID storage area 305, and a work area 307.

The collected data storage area 301 stores first status data received from first status communication terminals 1 located in the vicinity. The second status data storage area 302 stores second status data calculated based on the first status data collected in the collected data storage area 301.

FIG. 16 is an explanatory diagram conceptually illustrating the all terminal data storage area 303. The all terminal data storage area 303 stores values indicating the status of users of all terminals stored in the server 3. The third status data storage area 304 stores third status data. The specified ID storage area 305 stores IDs acquired from the ID infrared sensor 112. The work area 307 is used when the CPU 101 executes various processes.

As shown in FIG. 16, the all terminal data storage area 303 stores IDs for each terminal in association with values indicating the status of the corresponding users.

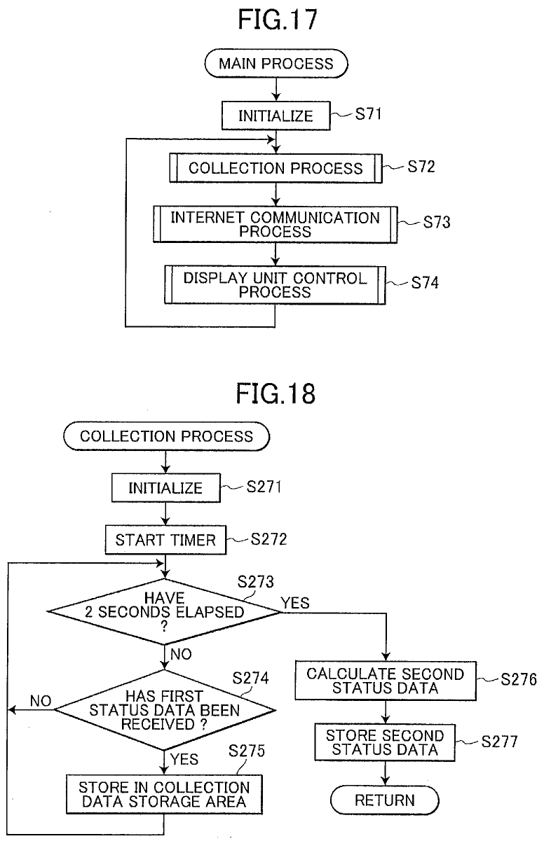

Next, the operations of the status collection terminal 100 will be described. FIG. 17 is a flowchart illustrating steps in a main process executed by the CPU 101 of the status collection terminal 100.

The CPU 101 executes the main process after the user operates a power button (not shown) on the status collection terminal 100 to turn on the power to the status collection terminal 100.

In S71 at the beginning of the process, the CPU 101 initializes each storage area of the RAM 103. In S72 the CPU 101 executes a collection process described next.

FIG. 18 is a flowchart illustrating steps in the collection process. In S271 at the beginning of the collection process shown in FIG. 18, the CPU 101 performs initialization.

In S272 the first status communication terminal 1 starts the timer to begin measuring elapsed time. In S273 the CPU 101 determines whether two seconds have elapsed since the timer was started.

If two seconds have not yet elapsed (S273: NO), then in S274 the CPU 101 determines whether first status data has been received from a first status communication terminal 1. If first status data has not been received (S274: NO), then the CPU 101 returns to S273.

If first status data has been received (S274: YES), then in S275 the CPU 101 stores the ID number of the first status communication terminal 1 from which the data was received together with the received first status data in the collected data storage area 301, and returns to S273.

When two seconds have elapsed after repeating the processes in S273-S275 (S273: YES), then in S276 the CPU 101 calculates the second status data.

Second status data is calculated as follows. First, the CPU 101 totals the values of all first status data stored in the collected data storage area 301, then divides the total by the number of communication terminals from which first status data was collected and rounds off the averaged value to obtain the second status data. The above calculation is performed without adding values of zero in the first status data.

In S277 the CPU 101 stores the calculated second status data in the second status data storage area 302 and returns to the main process.

After completing the collection process of S72 (FIG. 17), in S73 the CPU 101 executes an internet communication process.

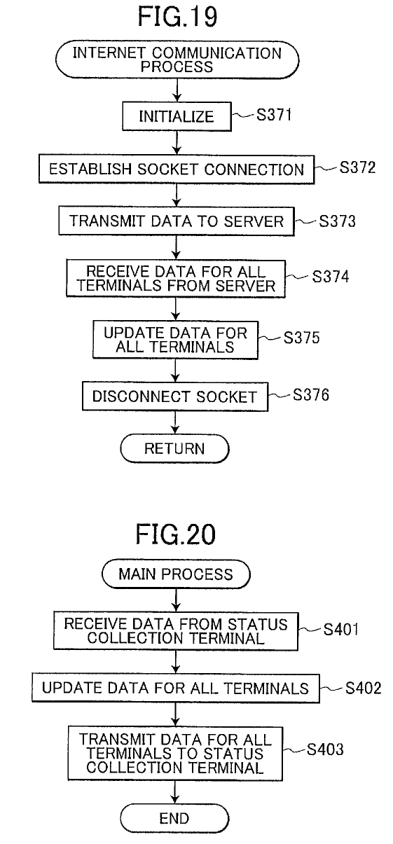

Next, the internet communication process will be described. FIG. 19 is a flowchart illustrating steps in the internet communication process. In S371 at the beginning of the internet communication process, the CPU 101 performs initialization.

In S372 the CPU 101 establishes a socket connection with the server 3. A socket connection is a connection in TCP/IP communications in which a socket (a network address configured of an IP address and a port number) is specified. In S373 the CPU 101 transmits the data stored in the collected data storage area 301 (the ID numbers and first status data for first status communication terminals 1 collected in the collection process), the ID number of the status collection terminal 100 itself, and the second status data stored in the second status data storage area 302 to the server 3 via the internet 4.

At this time, data for all terminals is stored on the HD 3A of the server 3 and includes values indicating the ID numbers for all first status communication terminals 1 and the status of their users, value indicating the ID numbers for all status collection terminals 100 and the status of their users, and values indicating the ID numbers of all second status communication terminals 2 and the status of their users. FIG. 20 is a flowchart illustrating steps in the main process executed by the server 3.

As shown in FIG. 20, in S401 the server 3 receives data via the transceiver 3B transmitted from the status collection terminal 100 in S373 described above. In S402 the server 3 overwrites the data for all terminals stored on the HD 3A with the received data. In S403 the server 3 transmits the updated data for all terminals via the transceiver 3B to the status collection terminal 100 that was the source of the data transmission, and ends the main process.

Returning to FIG. 19, in S374 the CPU 101 receives the data for all terminals transmitted from the server 3. In S375 the CPU 101 stores the received data in the all terminal data storage area 303. If data for all terminals already exists in the all terminal data storage area 303, the CPU 101 overwrites the existing data with the data received above. In S376 the CPU 101 disables the socket connection with the server 3 and returns to the main process.

After completing the internet communication process (FIG. 17), in S74 the CPU 101 executes the display unit control process.

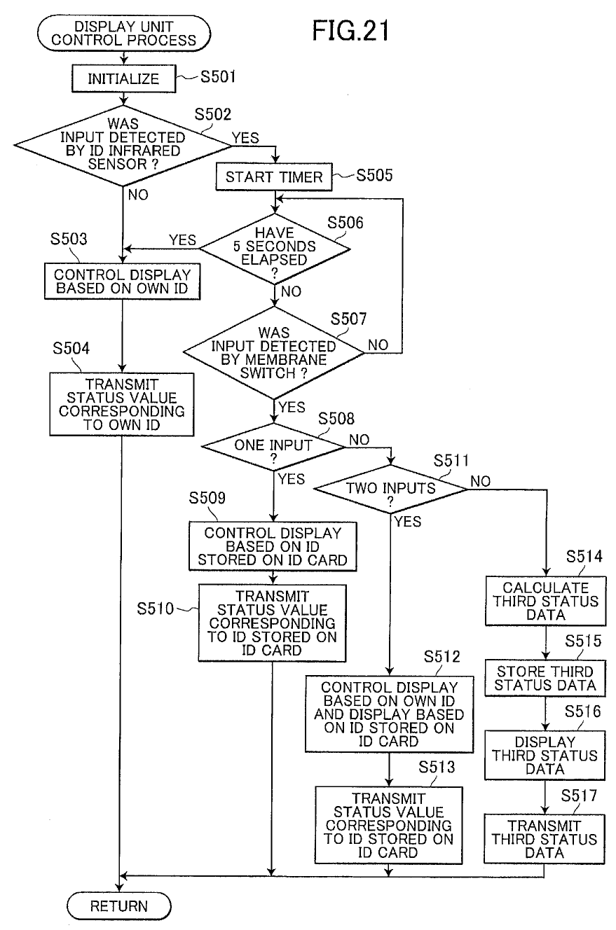

Next, the display unit control process will be described. FIG. 21 is a flowchart illustrating steps in this display unit control process. In S501 at the beginning of the display unit control process the CPU 101 performs initialization. In S502 the CPU 101 determines whether the ID infrared sensor 112 has received input.

If there is no input in the ID infrared sensor 112 (S502: NO), then in S503 the CPU 101 references a status value corresponding to the ID number of the status collection terminal 100 itself stored in the all terminal data storage area 303 (i.e., the second status data) and displays the color corresponding to this value on the display unit 107.

For example, if the second status data is “1”, indicating that the status of all users in the same community is “excited,” the CPU 101 displays the color red on the display unit 107. If the second status data is “2”, indicating that the status of users is “depressed,” the CPU 101 displays blue. If the second status data is “3”, indicating that the status of users is “sleepy,” the CPU 101 displays green. If the second status data is “0”, indicating that the status of users is “normal,” the CPU 101 displays no color. In this way, the user of the status collection terminal 100 can learn the overall state of the entire community to which the user belongs.

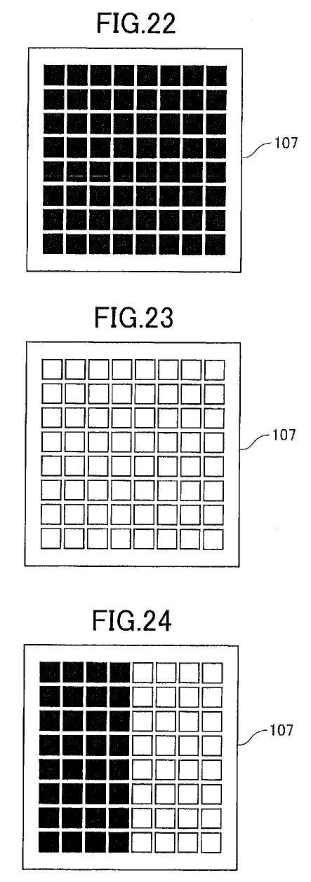

FIG. 22 shows a sample display on the display unit 107 in S503. In the example shown in FIG. 22, the value of the second status data is “1”, indicating that the status of the users is “excited.” While depicted in black in the drawing of FIG. 22, the color shown on the display unit 107 is red, which is the color indicating “excited.”

In S504 the CPU 101 transmits the second status data wirelessly from the transceiver 109 to the first status communication terminals 1.

At this time, all first status communication terminals 1 positioned within the wireless range of the status collection terminal 100 receive the second status data transmitted from the status collection terminal 100 in S504 and store the value for the second status data in the respective reception data storage area 135 in S17 of FIG. 7 described earlier. Consequently, in S18 of FIG. 7 the CPU 11 of the respective first status communication terminal 1 controls the LED 19 to emit light in the color corresponding to the second status data (i.e., the color corresponding to the overall status of users in the community to which the first status communication terminal 1 belongs).

However, when the CPU 101 determines in S502 that the ID infrared sensor 112 has received input (S502: YES), in S505 the CPU 101 stores the ID number on the ID card 116 in the specified ID storage area 305 and activates the timer 105 to begin measuring elapsed time. In S506 the CPU 101 determines whether five seconds have elapsed since the timer 105 was activated.

If five seconds have not elapsed (S506: NO), in S507 the CPU 101 determines whether the membrane switch 113 has received input. In S507 the CPU 101 accepts input via the membrane switch 113 for a prescribed period of time, such as three seconds, and stores a value indicating the number of times input was received during this period.

If input was not received via the membrane switch 113 (S507: NO), the CPU 101 returns to S506. If the CPU 101 detects no input in the membrane switch 113 during the five-second interval (S506: YES), then the CPU 101 advances to S503, references the ID number of the status collection terminal 100 itself in the all terminal data storage area 303, and displays on the display unit 107 a color corresponding to the status value stored in association with this ID number.

When the membrane switch 113 receives input within five seconds (S507: YES), in S508 the CPU 101 determines whether input was received only once. When the membrane switch 113 has received input only once (S508: YES), in S509 the CPU 101 reads the ID number stored in the specified ID storage area 305, references the ID number in the all terminal data storage area 303, and displays on the display unit 107 the color corresponding to the state associated with this ID number.

As described above, the ID card 116 stores an ID number assigned to either a first status communication terminal 1, a second status communication terminal 2, or a status collection terminal 100.

Therefore, when the ID number stored on the ID card 116 corresponds to a first status communication terminal 1, the CPU 101 displays the state of the user of the first status communication terminal 1; if the ID number is assigned to a second status communication terminal 2, the CPU 101 displays the state of the user of that second status communication terminal 2; and if the ID number is assigned to a status collection terminal 100, the CPU 101 displays the overall state of all users of the status collection terminal 100.

FIG. 23 shows a sample display of the display unit 107 in S509. The example shown in FIG. 23 indicates that the user of the terminal whose ID number is specified on the ID card 116 has a state of 3 (sleepy). While the display in FIG. 23 appears white, the display on the display unit 107 is actually green, which is the color indicating “sleepy.”

In S510 the CPU 101 transmits a value for the state corresponding to the ID number to the first status communication terminals 1 and returns to the main process.

However, if the CPU 101 determines that the membrane switch 113 received input more than once (S508: NO), then in S511 the CPU 101 determines whether the membrane switch 113 received input twice.

If the membrane switch 113 received input twice (S511: YES), then in S512 the CPU 101 references the all terminal data storage area 303 with the ID number of the status collection terminal 100 itself and the ID number stored in the specified ID storage area 305 and displays on the display unit 107 colors corresponding to the states associated with these ID numbers.

FIG. 24 shows a sample display on the display unit 107 in S512. The example in FIG. 24 shows a case in which the state corresponding to the ID number of the status collection terminal 100 itself stored in the all terminal data storage area 303 is 1 (excited) and the state corresponding to the ID number stored in the specified ID storage area 305 is 3 (sleepy). In this case, the CPU 101 displays red (indicated in black in the drawing) in the left half of the display unit 107, depicting the state corresponding to the ID number of the status collection terminal 100 itself, and displays green (indicated in white in the drawing) in the right half of the display unit 107, depicting the state corresponding to the ID number stored in the specified ID storage area 305.

After controlling the display on the display unit 107 in this way, in S513 the CPU 101 wirelessly transmits a state value for the ID number stored on the ID card 116 to the first status communication terminal 1 from the transceiver 109 and returns to the main process.

However, if the CPU 101 determines in S511 that the membrane switch 113 was pressed more than twice (S511: NO), then in S514 the CPU 101 calculates the third status data based on the state value for the ID number of the status collection terminal 100 itself stored in the all terminal data storage area 303 and the state number for the ID number stored in the specified ID storage area 305. More specifically, the CPU 101 calculates the third status data by adding the state value for the ID number of the status collection terminal 100 itself to the state value for the ID number stored in the specified ID storage area 305, dividing this sum by 2, and rounding off the obtained number.

In S515 the CPU 101 stores the value for the third status data calculated as above in the third status data storage area 304.

In S516 the CPU 101 controls the display on the display unit 107 based on the third status data stored in the third status data storage area 304.

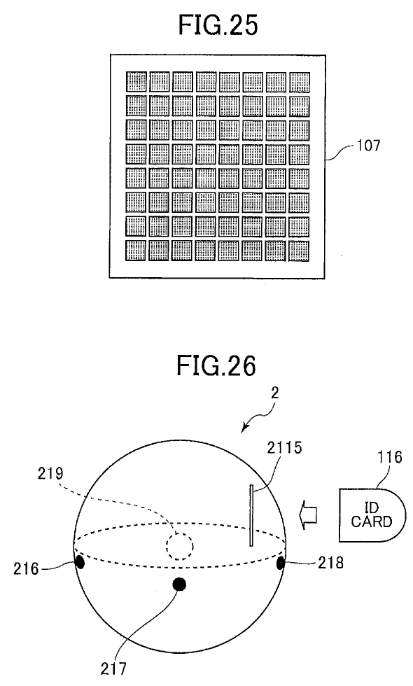

FIG. 25 shows a sample display on the display unit 107 in S516. The example in FIG. 25 indicates the case in which the third status data stored in the third status data storage area 304 has the value 2 (depressed). As shown in FIG. 25, the CPU 101 displays blue (indicated in gray in the drawing) on the display unit 107 since blue depicts the state “depressed.”

In S517 the CPU 101 wirelessly transmits the value of the third status data to the first status communication terminals 1 from the transceiver 109 and returns to the main process.

After completing the display unit control process described above, the CPU 101 returns to S72 in the main process of FIG. 17 and repeats the process of S72-S74.

Next, the second status communication terminal 2 will be described in greater detail.

FIG. 26 is a front view of the second status communication terminal 2. The second status communication terminal 2 is similar in size to the first status communication terminal 1 and has a casing of similar structure to that of the first status communication terminal 1, except that a slot 2115 is formed in the surface of the second status communication terminal 2 for inserting the ID card 116.

A disc-shaped circuit board is provided inside the casing of the second status communication terminal 2 in a plane passing through the center of the casing and parallel to the surface on which the bottom of the casing is placed. The circuit board is connected to various sensors 216-218 and an LED 219.

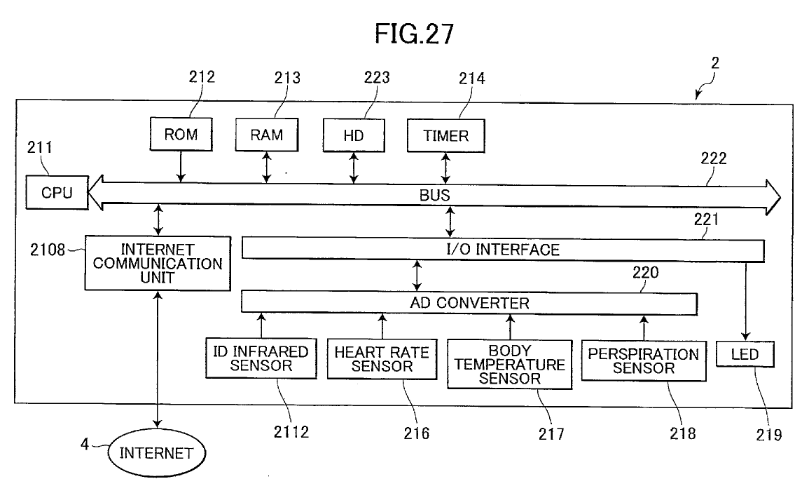

FIG. 27 is a block diagram showing the electrical structure of the second status communication terminal 2. As shown in FIG. 27, a CPU 211 is disposed inside the casing of the second status communication terminal 2 for controlling operations of the second status communication terminal 2. The CPU 211 is connected via a bus 222 to a ROM 212 storing control programs and the like, a RAM 213 for temporarily storing various data, a hard disk (HD) 223 for storing various data, a timer 214 for measuring elapsed time, an internet communication unit 2108 for exchanging data with the internet 4, and an I/O interface 221 for connecting various modules. Power is supplied to the second status communication terminal 2 from a battery (not shown).

The second status communication terminal 2 is also provided with an AD converter 220 connected to the sensors 216-218, and an ID infrared sensor 2112. The AD converter 220 is connected to the CPU 211 via the I/O interface 221 and bus 222 and functions to convert measured analog values received from the sensors 216-218 and the ID infrared sensor 2112 into digital data and to input this digital data into the CPU 211.

The sensors 216-218 have similar functions to the sensors 16-18 of the first status communication terminal 1. The ID infrared sensor 2112 has a similar function to the ID infrared sensor 112 of the status collection terminal 100 for acquiring the ID stored on the ID card 116 inserted into the slot 2115. The LED 219 is similar to the LED 19 of the first status communication terminal 1 and is connected to the CPU 211 via the I/O interface 221 and bus 222. The CPU 211 outputs instruction signals that are inputted into the LED 219 via the I/O interface 221 and bus 222.

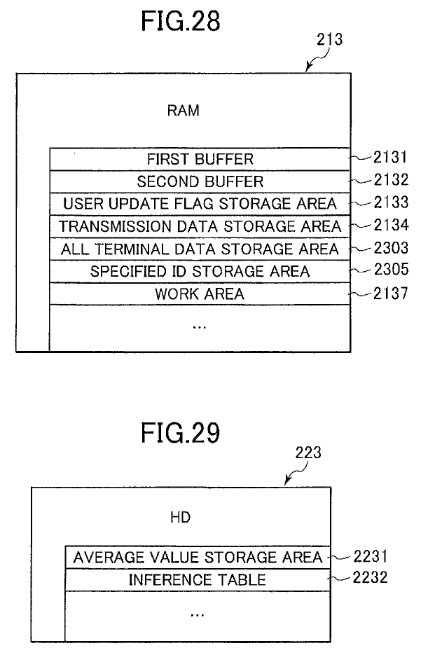

Next, the structure of storage areas in the RAM 213 will be described. FIG. 28 is an explanatory diagram showing the structure of the storage areas.

As shown in FIG. 28, the RAM 213 is provided with a first buffer 2131, a second buffer 2132, a user update flag storage area 2133, a transmission data storage area 2134, an all terminal data storage area 2303, a specified ID storage area 2305, and a work area 2137.

The first buffer 2131, second buffer 2132, user update flag storage area 2133, transmission data storage area 2134, and work area 2137 are identical to the first buffer 131, second buffer 132, user update flag storage area 133, transmission data storage area 134, and work area 137 of the first status communication terminal 1 shown in FIG. 4.

The all terminal data storage area 2303 and specified ID storage area 2305 are also similar to the all terminal data storage area 303 and specified ID storage area 305 of the status collection terminal 100 shown in FIG. 15.

Next, the structure of the storage area in the HD 223 will be described. FIG. 29 is an explanatory diagram showing the structure of this storage area.

As shown in FIG. 29, the HD 223 includes an average value storage area 2231, and an inference table 2232. The average value storage area 2231 and inference table 2232 are similar to the average value storage area 231 and inference table 232 of the first status communication terminal 1 shown in FIG. 5.

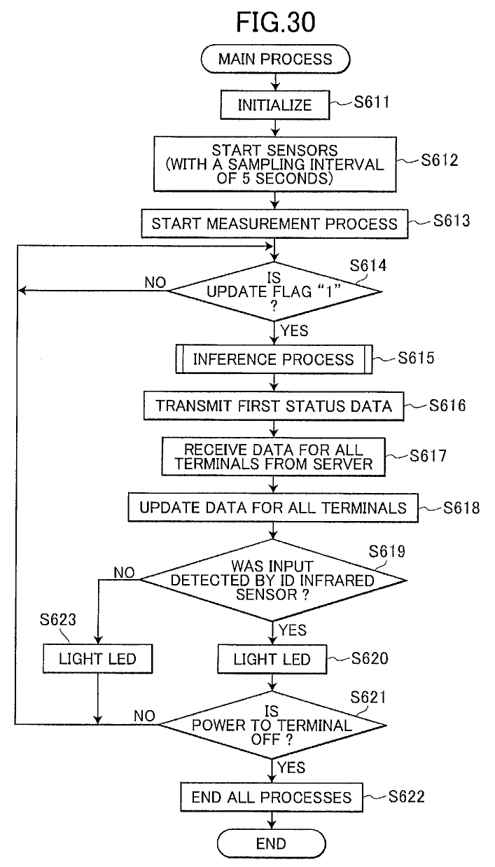

Next, the operations of the second status communication terminal 2 will be described. FIG. 30 is a flowchart illustrating steps in a main process executed by the CPU 211 of the second status communication terminal 2. The CPU 211 begins this process when the user turns on the power of the second status communication terminal 2 by pressing a power button (not shown).

Steps S611-S616 in the main process of FIG. 30 are identical to steps S11-S16 in the main process performed by the first status communication terminal 1 (see FIG. 7).

In other words, by completing the process S616, the CPU 211 will have transmitted first status data indicating the status of the user of the second status communication terminal 2 and the ID number of the second status communication terminal 2 itself from the internet communication unit 2108 to the server 3 via the internet 4.

Upon receiving the ID number and first status data from the second status communication terminal 2, the server 3 updates data for all terminals and transmits the updated data to the second status communication terminal 2.

In S617 the CPU 211 receives the data for all terminals from the server 3 and in S618 stores this received data in the all terminal data storage area 2303. If data for all terminals was previously stored in the all terminal data storage area 2303, the CPU 211 overwrites the existing data with the data received above.

In S619 the CPU 211 determines whether the ID infrared sensor 2112 has received input.

If the ID infrared sensor 2112 has received no input (S619: NO), then in S623 the CPU 211 references the state value corresponding to the ID number of the second status communication terminal 2 itself stored in the all terminal data storage area 2303 (the first status data) and controls the LED 219 to emit light of the color corresponding to this state value. Subsequently, the CPU 211 returns to S614.

However, if the ID infrared sensor 2112 has received input (S619: YES), then in S620 the CPU 211 reads the ID number stored in the specified ID storage area 2305, references this ID number in the all terminal data storage area 2303, and controls the LED 219 to emit a color corresponding to the state value associated with the ID number and a color corresponding to the state value associated with the ID number of the second status communication terminal 2 itself.

In S621 the CPU 211 determines whether the power has been turned off. If the power has not been turned off (S621: NO), then the CPU 211 returns to S614. If the power has been turned off (S621: YES), then in S622 the CPU 211 ends all processes and subsequently quits the main process.

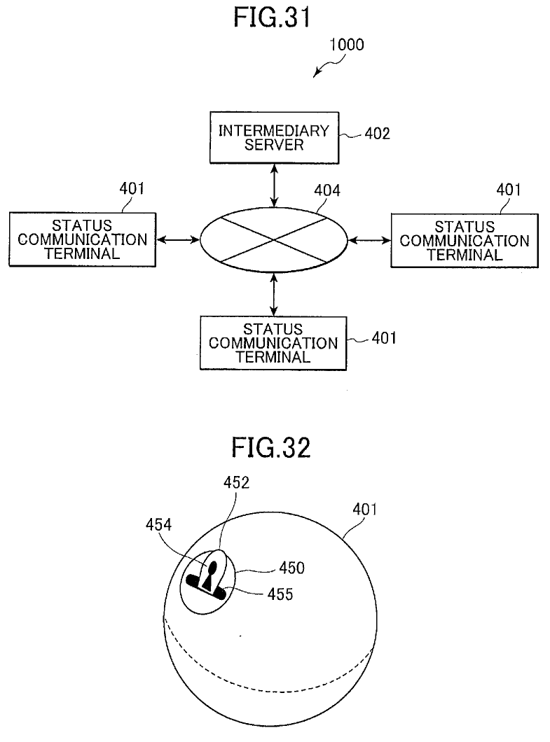

Next, a second embodiment of the present invention will be described. First, the overall structure of a status communication system 1000 will be described. The status communication system 1000 implements communications between status communication terminals of the present invention via an intermediary server. FIG. 31 is a block diagram showing the structure of the status communication system 1000.

As shown in FIG. 31, the status communication system 1000 includes a plurality of status communication terminals 401 capable of rendering the status of the users and their environments, an internet 404 to which the status communication terminals 401 are connected, and an intermediary server 402 also connected to the internet 404 for mediating communications among the status communication terminals 401. Each of the status communication terminals 401 has various sensors described later. Each of the status communication terminals 401 infers the status of users and their environment based on sensing data provided from the sensors and transmits the results of inference to the intermediary server 402. The status communication terminal 401 also acquires status inference results by other status communication terminals 401 from the intermediary server 402 and uses an LED or other rendering means to render the own status as well as the status of other status communication terminals 401, based on the status inference results.

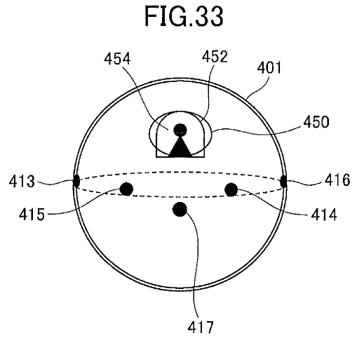

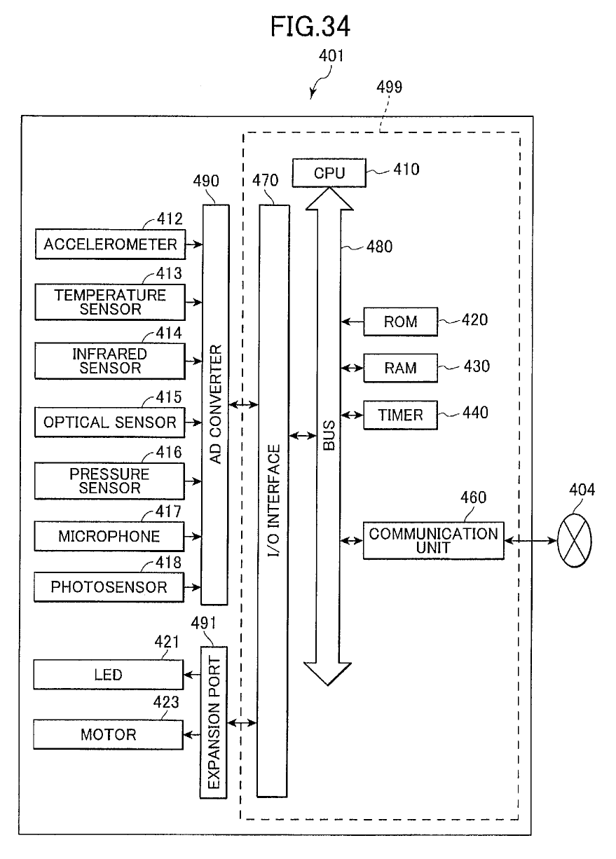

Next, the status communication terminal 401 will be described. FIG. 32 is an oblique top view of the status communication terminal 401. FIG. 33 is a front view of the status communication terminal 401. FIG. 34 is a block diagram showing the electrical structure of the status communication terminal 401.

As shown in FIGS. 32 and 33, the status communication terminal 401 is spherical in shape and of an appropriate size for the user to grip with one or two hands. The status communication terminal 401 has a spherical casing formed of a transparent synthetic resin at a thickness of several millimeters (5 mm, for example). The interior space defined by the casing is also spherical and hermetically sealed.

A mounting part 455 is provided in the upper front side of the casing constituting the status communication terminal 401. The mounting part 455 opens upward for inserting a card-like identification member 452. The opening of the mounting part 455 is provided in a recessed part 450 formed in the surface of the casing so that the mounting part 455 does not protrude from the casing and so that the user can easily see and grip the identification member 452 to insert or remove the same from the mounting part 455. A photosensor 418 (see FIG. 34) configured of a reflective photointerrupter is provided inside the casing below the mounting part 455 for reading data specifying another status communication terminal 401 that is provided on the identification member 452.

The identification member 452 is formed substantially in a semispherical card shape. The surface of the identification member 452 forms a display area 454 for providing visual identification data for the user, such as a profile picture, name, and the like of the user at the specified communication destination. A reflecting slit (not shown) is also provided in the lower underside surface of the card for indicating the ID of the specified status communication terminal read by the photosensor 418. When the identification member 452 is mounted into the mounting part 455 from above so that the underside surface of the card in which the slit is formed opposes the photosensor 418, the photosensor 418 reads the ID of the specified status communication terminal and stores this ID in a RAM 430 (see FIG. 34) as a specified terminal described later.

A disc-shaped circuit board is also disposed inside the casing of the status communication terminal 401 on a plane that passes through the center of the casing and is parallel to the surface on which the bottom of the casing is placed. Mounted on or connected to this circuit board are various sensors 412-418, actuators 421 and 423, and a control unit 499 (see FIG. 34).

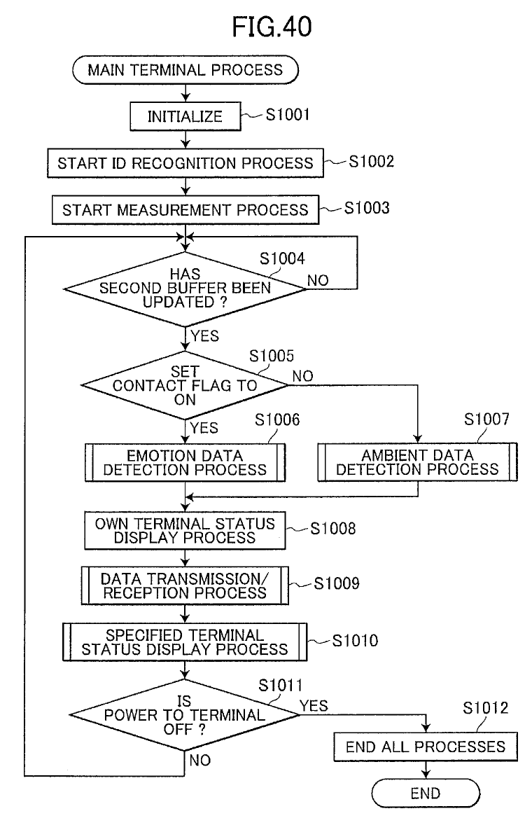

As shown in FIG. 34, a CPU 410 is provided on the control unit 499 inside the casing of the status communication terminal 401 for controlling the status communication terminal 401. Also provided on the control unit 499 and connected to the CPU 410 via a bus 480 are a ROM 420, the RAM 430 for temporarily storing various data, a timer 440 for measuring elapsed time, a communication unit 460 for communicating with the intermediary server 402, and an I/O interface 470 for connecting various modules. Power is supplied to the status communication terminal 401 from a battery (not shown). The ROM 420 stores a status communication program for implementing the processes described later in FIGS. 40-47.

The status communication terminal 401 also includes an AD converter 490 connected to each of the sensors 412-418, and an expansion port 491 for inserting the actuators 421 and 423. The AD converter 490 is connected to the CPU 410 via the I/O interface 470 and the bus 480. The AD converter 490 converts analog measurement data from the sensors 412-418 into digital data and inputs this digital data into the control unit 499. The expansion port 491 is also connected to the CPU 410 via the I/O interface 470 and the bus 480. Digital instruction signals outputted from the control unit 499 are inputted into the actuators 421 and 423 via the expansion port 491. The sensors 412-418 can be detachably mounted in and added to the AD converter 490, exchanged with other sensors, and the like, while the actuators 421 and 423 can be detachably mounted in and added to the expansion port 491, exchanged with other actuators, and the like.

Next, the sensors 412-417 will be described. The accelerometer 412 employs variations in capacitance, piezoelectric ceramics, and the like for measuring motion of the status communication terminal 401 (the magnitude and direction of acceleration acting on the status communication terminal 401). The temperature sensor 413 is a temperature indicator employing a platinum resistance temperature detector, a thermistor, a thermocouple, or the like for measuring the ambient temperature of the status communication terminal 401 and the temperature of the user's fingers or palms touching the status communication terminal 401. The infrared sensor 414 counts pulse signals to measure the heart rate (pulse rate) of the person touching the status communication terminal 401 or peripheral motion when the user is not touching the status communication terminal 401. The optical sensor 415 is disposed on the surface of the status communication terminal 401, employing a phototransistor, CdS, or the like for measuring light intensity.

The pressure sensor 416 is disposed on the surface of the status communication terminal 401 and configured of a fixed resistor connected in series to a conductive rubber. The pressure sensor 416 measures pressure applied to the status communication terminal 401 by measuring the value of divided voltage in the conductive rubber when a prescribed voltage is applied to the pressure sensor 416. The microphone 417 inputs voice or sounds around the status communication terminal 401.

As shown in FIG. 33, the temperature sensor 413, infrared sensor 414, optical sensor 415, pressure sensor 416, and microphone 417 are disposed on the casing surface of the status communication terminal 401 near the plane passing through the center of the casing. When the optical sensor 415 is mounted in the mounting part 455 and the user grips the status communication terminal 401 so as to be able to view the display area 454, the user's fingers contact the temperature sensor 413, infrared sensor 414, optical sensor 415, and pressure sensor 416, allowing these sensors to measure biological data of the user appropriately. Further, the microphone 417 is positioned on the side facing the user in order to easily pick up sounds around the user. Alternatively, if the user places the status communication terminal 401 on a surface so that the display area 454 on the identification member 452 mounted in the mounting part 455 is visible, the microphone 417 is positioned toward the user in order to easily pick up sounds around the user.

Next, the actuators 421 and 423 will be described. The actuators include an LED 421 and a motor 423 for rendering the inferred status values obtained based on sensing data. The LED 421 can be lit in various colors (green, blue, yellow, red, and the like) and at various brightnesses, and can emit light in desired directions (upward, downward, and the like). The motor 423 vibrates the status communication terminal 401. The actuators may also include a buzzer and the like and are not limited to the LED and motor.

The status communication terminal 401 is not provided with a computer keyboard or the like. Therefore, data detected by the sensors 412-417 is preregistered on the status communication terminal 401 as instructional input instructing the execution of prescribed operations. The user instructs the status communication terminal 401 to perform an operation by gripping or moving the status communication terminal 401 (for example, shaking or gripping the status communication terminal 401 a prescribed number of times).

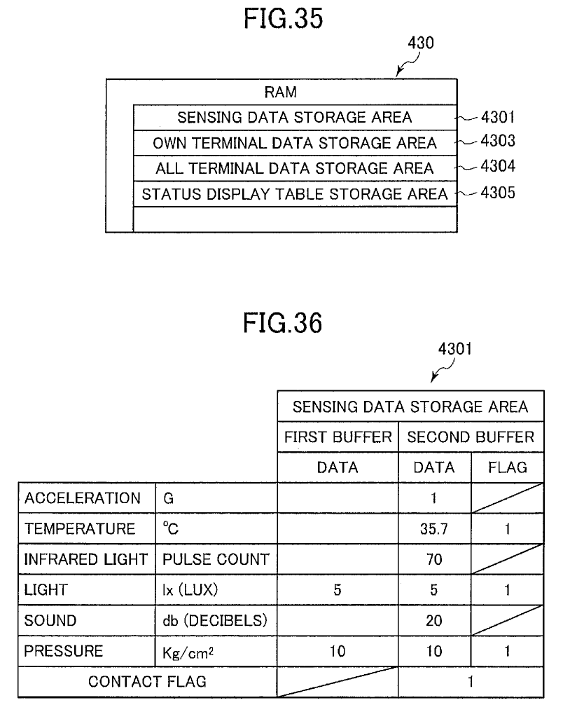

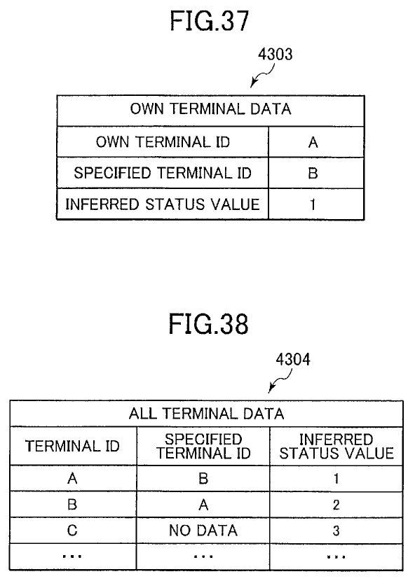

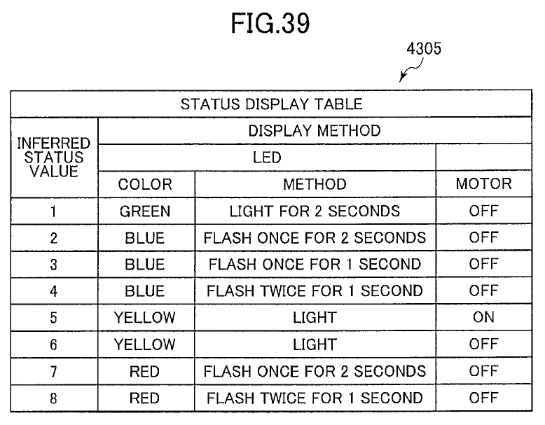

Next, the structure of the storage area in the RAM 430 storing tables and the like used by the status communication terminal 401 will be described with reference to FIGS. 35-39. FIG. 35 is an explanatory diagram conceptually illustrating the structure of the storage area in the RAM 430. FIG. 36 is an explanatory diagram conceptually illustrating the structure of a sensing data storage area 4301 in the RAM 430. FIG. 37 is an explanatory diagram conceptually illustrating the structure of an own terminal data storage area 4303. FIG. 38 is an explanatory diagram conceptually illustrating the structure of an all terminal data storage area 4304. FIG. 39 is an explanatory diagram conceptually illustrating the structure of a status display table stored in a status display table storage area 4305.

As shown in FIG. 35, the RAM 430 includes the sensing data storage area 4301 for storing sensing data measured by the sensors 412-417; the own terminal data storage area 4303 for storing the ID of the status communication terminal 401 itself, the ID of a specified status communication terminal, and the inferred status value for the status communication terminal 401 itself; the all terminal data storage area 4304 for storing IDs of all status communication terminals, IDs of specified status communication terminals, and inferred status values for the status communication terminals received from the intermediary server 402; the status display table storage area 4305 for storing a status display table used to control the actuators in displaying a status based on the inferred status value; and other storage areas not shown in FIG. 35.

As shown in FIG. 36, the sensing data storage area 4301 has a first storage buffer and a second storage buffer. The first storage buffer is used to store sensing data detected by the sensors 412-417 and converted to digital data by the AD converter 490, including acceleration data, temperature data, infrared data, light data, sound data, and pressure data. This data is saved to the first storage buffer after each measurement. Once sensing data has been accumulated from all sensors, the data is copied to the second storage buffer, and a flag process is performed to determine whether the user is touching the status communication terminal 401. Values saved to the second storage buffer are also used in an emotion data detection process and an ambient data detection process described later. For simplification, values of sensing data indicated in FIG. 36 have been converted by the AD converter 490 to digital data from the analog voltage values outputted by the sensors and further converted to the appropriate units, but it is also possible to use the digital values converted directly from the sensors' voltage values by the AD converter 490.

As shown in FIG. 37, the own terminal data storage area 4303 stores a preset ID (“A” in the example of FIG. 37) as data identifying the status communication terminal 401 itself, the ID of another status communication terminal 401 (“B” in the example of FIG. 37) specified by mounting the identification member 452 in the mounting part 455, and an inferred status value (“1” in the example of FIG. 37) outputted as a result of inferring the status based on sensing data. When the identification member 452 is not mounted in the mounting part 455, the value “no data” is stored for the specified terminal ID.

As shown in FIG. 38, the all terminal data storage area 4304 stores data on all status communication terminals 401 received from the intermediary server 402. Similar to the own terminal data stored in the own terminal data storage area 4303, data items stored in the all terminal data storage area 4304 include IDs of the status communication terminals 401, IDs of other status communication terminals specified by the respective status communication terminals 401, and inferred status values outputted by the status communication terminals 401.

As shown in FIG. 39, the status display table storage area 4305 stores a status display table for rendering states on the status communication terminal 401 via actuators based on inferred status values obtained through the emotion data detection process and ambient data detection process, or inferred status values received for other status communication terminals 401. The method of displaying these states is identical for the inferred status value of the status communication terminal 401 itself and the inferred status values of other status communication terminals 401. Specifically, if the inferred status value is “1”, the LED 421 is lit in green for two seconds, while the motor 423 remains off. If the inferred status value is “2”, the LED 421 is flashed once in blue over a two-second period, while the motor 423 remains off. If the inferred status value is “3”, the LED 421 is flashed once in blue over a one-second period, while the motor 423 remains off. If the inferred status value is “4”, the LED 421 is flashed twice in blue for a period of one second, while the motor 423 is left off. If the inferred status value is “5”, the LED 421 is lit in yellow, and the motor 423 is turned on. If the inferred status value is “6”, the LED 421 is lit in yellow, while the motor 423 is left off. If the inferred status value is “7”, the LED 421 is flashed once in red over a two-second period, while the motor 423 is left off. If the inferred status value is “8”, the LED 421 is flashed twice in red for one second, while the motor 423 is left off. Since the LED 421 can be lit in a specified direction, as described above, the status of the status communication terminal 401 itself can be displayed in the lower section of the status communication terminal 401, while the status of the specified terminal can be displayed in the upper section. The method of displaying states is not limited to the example shown in FIG. 39. For example, the LED 421 may display light in gradations rather than simply turning on or flashing lights. The degree of vibration generated by the motor 423 may also be varied. States can be rendered in many other ways by connecting other actuators, such as a buzzer.

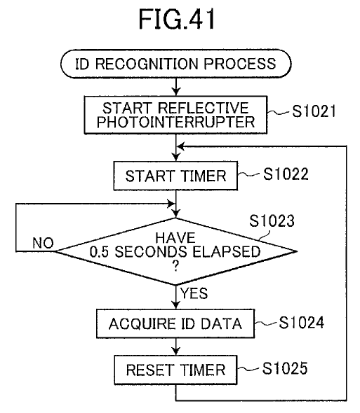

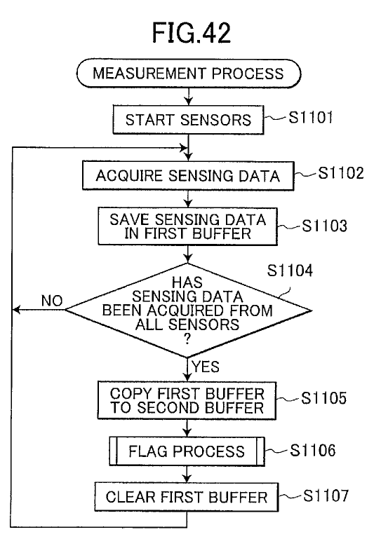

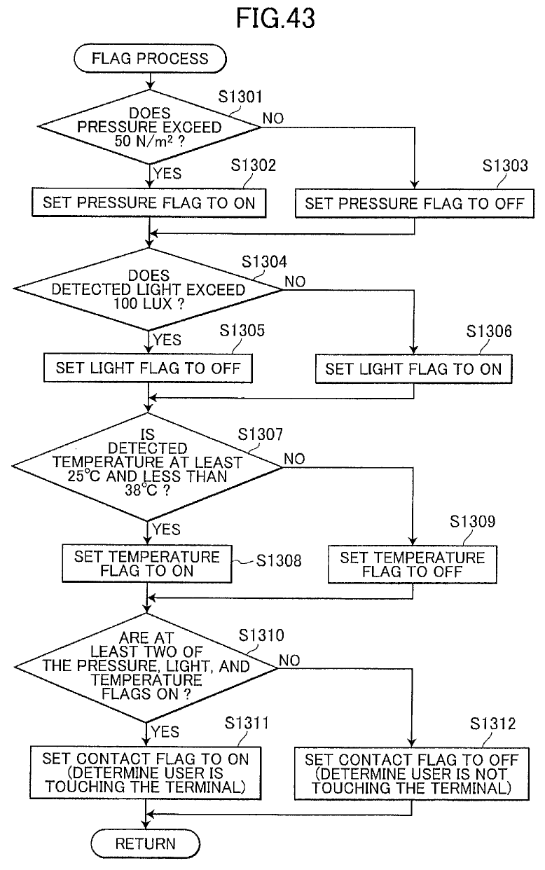

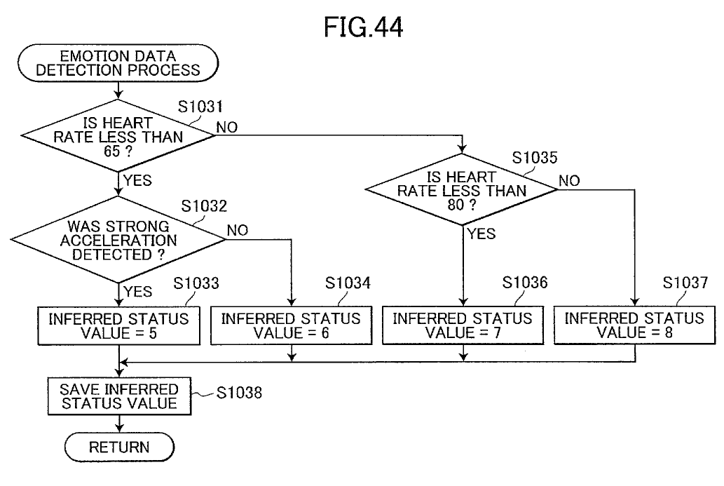

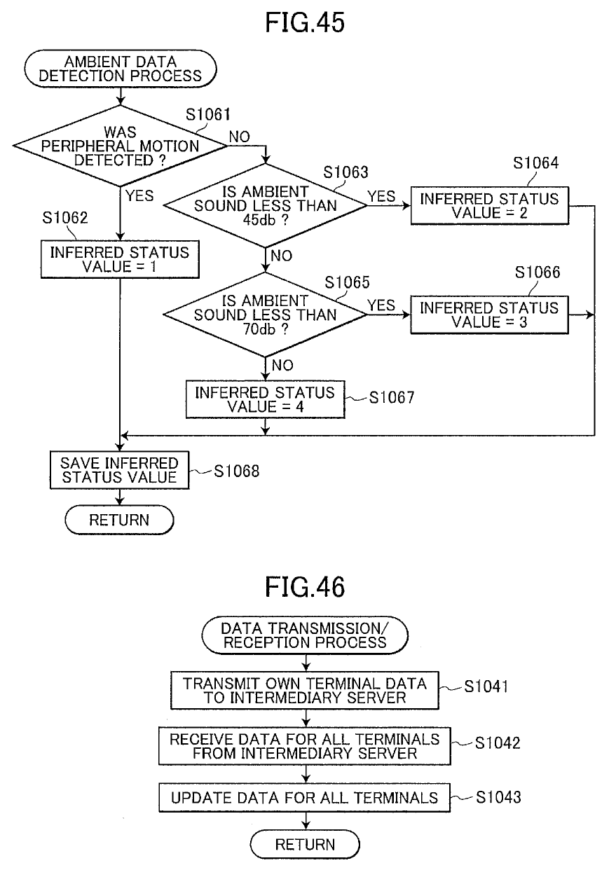

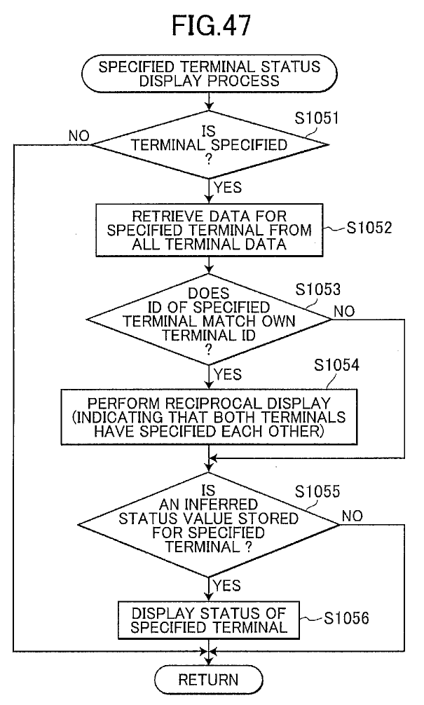

Next, the operations of the status communication terminal 401 having the above structure will be described. FIG. 40 is a flowchart illustrating steps in a main process executed on the status communication terminal 401. FIG. 41 is a flowchart illustrating steps in an ID recognition process initiated during the main process. FIG. 42 is a flowchart illustrating steps in a measurement process initiated during the main process. FIG. 43 is a flowchart illustrating steps in a flag process executed during the measurement process. FIG. 44 is a flowchart illustrating steps in an emotion data detection process executed during the main process. FIG. 45 is a flowchart illustrating steps in an ambient data detection process executed during the main process. FIG. 46 is a flowchart illustrating steps in a data transmission/reception process executed during the main process. FIG. 47 is a flowchart illustrating steps in a specified terminal status display process executed during the main process. The CPU 410 of the status communication terminal 401 continuously executes the main process according to the preferred embodiment (FIG. 40) by launching a status communication program when a battery is inserted in the status communication terminal 401 and the power to the status communication terminal 401 is switched on.

In S1001 at the beginning of the main process shown in FIG. 40, the CPU 410 initializes various data, flags, and the like. For example, the CPU 410 initializes the sensing data storage area 4301 in the RAM 430 and clears a count value for counting the number of gestures.

In S1002 the CPU 410 initiates an ID recognition process for reading the ID of a communication destination from the identification member 452 using the photosensor 418. The ID recognition process will be described later in greater detail with reference to FIG. 41. The ID recognition process is repeatedly executed until an end instruction is received.

In S1003 the CPU 410 initiates a measurement process for acquiring measurement values from the sensors 412-417 to determine whether the user is contacting the casing of the status communication terminal 401. The measurement process will be described later in greater detail with reference to FIG. 42. The measurement process is repeatedly executed until an end instruction is received.

In S1004 the CPU 410 determines whether the second storage buffer in the sensing data storage area 4301 has been updated, i.e., whether an update flag stored in the RAM 430 is set to “1”. As will be described later, the CPU 410 updates the second storage buffer in the sensing data storage area 4301 in the measurement process by copying data from the first storage buffer when new sensing data has been obtained from all sensors, and detects whether the user is touching the status communication terminal 401 based on the new sensing data (see FIGS. 42 and 43). Hence, when the second storage buffer is updated, indicating that new sensing data has been obtained, the CPU 410 can determine whether the user is contacting the status communication terminal 401 and detect emotion data and ambient data based on the new sensing data. Therefore, if the second storage buffer has not been updated (S1004: NO), the CPU 410 repeatedly loops back to S1004 while waiting for the second storage buffer to be updated.

When the second storage buffer has been updated (S1004: YES), in S1005 the CPU 410 determines whether the user is touching the status communication terminal 401 by checking a contact flag set in the measurement process. If the contact flag is ON (S1005: YES), in S1006 the CPU 410 executes an emotion data detection process to calculate an inferred status value based on data acquired in the measurement process. If the contact flag is OFF (S1005: NO), in S1007 the CPU 410 executes an ambient data detection process to calculate an inferred status value based on data acquired in the measurement process. The emotion data detection process and the ambient data detection process will be described later in greater detail with reference to FIGS. 44 and 45, respectively.

In S1008 the CPU 410 indicates the status of the status communication terminal 401 itself using the actuators 421 and 423 based on the inferred status value stored in the own terminal data storage area 4303 (see FIG. 37) and the status display table stored in the status display table storage area 4305 (see FIG. 39). For example, if the inferred status value is “1”, the CPU 410 lights the LED 421 in green for a period of two seconds. The status of the status communication terminal 401 itself is displayed in the lower half of the status communication terminal 401.

In S1009 the CPU 410 executes the data transmission/reception process to transmit an inferred status value acquired in the emotion data detection process or ambient data detection process to the intermediary server 402 and receives inferred status values for all terminals including the status communication terminal 401 itself and other status communication terminals 401 from the intermediary server 402. The data transmission/reception process will be described later in greater detail with reference to FIG. 46.

In S1010 the CPU 410 executes the specified terminal status display process for displaying states using the actuators based on the inferred status value of the other status communication terminal 401 specified as the status to be displayed from among all terminal data received from the intermediary server 402. The specified terminals status display process will be described later in greater detail with reference to FIG. 47.

In S1011 the CPU 410 determines whether the power to the status communication terminal 401 has been turned off. If the power has not been turned off (S1011: NO), then the CPU 410 returns to S1004 and repeats the process described above. However, if the power has been turned off (S1011: YES), then in S1012 the CPU 410 ends all current processes and quits the main process.

Next, the ID recognition process initiated during the main process will be described with reference to FIG. 41. In S1021 at the beginning of the ID recognition process, the CPU 410 activates a reflective photointerrupter in the photosensor 418. In S1022 the CPU 410 starts the timer.

In S1023 the CPU 410 determines whether 0.5 seconds have elapsed. If 0.5 seconds have not yet elapsed (S1023: NO), the CPU 410 repeatedly loops back to S1023 until 0.5 seconds have elapsed. Once 0.5 seconds have elapsed (S1023: YES), in S1024 the CPU 410 acquires ID data from the reflecting slit in the identification member 452. The CPU 410 stores the acquired ID data in the own terminal data storage area 4303 (see FIG. 37) as the specified terminal ID. In S1025 the CPU 410 resets the timer and returns to S1022. By repeatedly performing the above process, the CPU 410 acquires ID data from the identification member 452 at intervals of 0.5 seconds. Since ID data cannot be acquired when the identification member 452 is not mounted in the mounting part 455, the specified terminal ID is set to “no data” in the own terminal data storage area 4303.

Next, the measurement process initiated during the main process will be described with reference to FIG. 42. At the beginning of the measurement process in S1102, the CPU 410 activates the sensors 412-417 to begin measuring. In S1102 the CPU 410 acquires sensing data from the sensors and in S1103 saves the acquired sensing data in the first storage buffer of the sensing data storage area 4301. For example, if the CPU 410 acquires only sensing data from the pressure sensor 416 and optical sensor 415, the CPU 410 stores only pressure data and light data in the sensing data storage area 4301, as shown in the example of FIG. 36.

In S1104 the CPU 410 determines whether sensing data has accumulated in the first storage buffer for all sensors. If data has not yet been acquired from all sensors (S1104: NO), the CPU 410 returns to S1102 until all measurements have been completed and all sensor data acquired. For example, if the first storage buffer of the sensing data storage area 4301 stores only pressure data and light data as described above, the CPU 410 repeatedly acquires sensing data until the first storage buffer also accumulates acceleration data, temperature data, infrared data, and sound data.

Once the first storage buffer stores sensing data from all sensors (S1104: YES), in S1105 the CPU 410 copies the data from the first storage buffer to the second storage buffer. At this time, the CPU 410 sets an update flag (not shown) in the RAM 430 to “1”. In S1106 the CPU 410 executes the flag process for determining based on the sensing data whether the user is touching the status communication terminal 401. The flag process will be described later in greater detail with reference to FIG. 43.

After completing the flag process, in S1107 the CPU 410 clears the data in the first storage buffer in order to acquire subsequent sensing data. Next, the CPU 410 returns to S1102 and repeats the process for acquiring and saving sensing data described above.

Since the measurement process is continually executed as described above, the second storage buffer of the RAM 430 always stores sensing data that can be used when the CPU 410 executes the emotion data detection process or ambient data detection process in S1006 or S1007 of the main process described in FIG. 40 based on this sensing data.

Next, the flag process executed during the above measurement process will be described with reference to FIG. 43. In S1301 of the flag process the CPU 410 determines whether the pressure sensor 416 detected pressure. If the pressure sensor 416 detected a pressure of 50 N/m² or greater (S1301: YES), then in S1302 the CPU 410 sets the pressure flag to ON, i.e., stores a “1” in the pressure flag provided in the second storage buffer of the sensing data storage area 4301. However, if the detected pressure is less than 50 N/m² (S1301: NO), in S1303 the CPU 410 sets the pressure flag to OFF, i.e., stores a “0” in the pressure flag of the second storage buffer.

In S1304 the CPU 410 determines whether the optical sensor 415 has detected light. If the optical sensor 415 has detected at least 100 lux of light (S1304: YES), then in S1305 the CPU 410 sets the light flag to OFF, i.e., stores a “0” in the light flag of the second storage buffer. If less than 100 lux of light were detected (S1304: NO), then in S1306 the CPU 410 sets the light flag to ON, i.e., stores a “1” in the light flag of the second storage buffer.

In S1307 the CPU 410 determines whether the temperature sensor 413 has detected a temperature of at least 25° and less than 38°. IF the temperature sensor 413 has detected a temperature within this range (S1307: YES), then in S1308 the CPU 410 sets a temperature flag to ON, i.e, stores a “1” in the temperature flag of the second storage buffer. However, if the detected temperature is not within the range of at least 25° and less than 38° (S1307: NO), then in S1309 the CPU 410 sets the temperature flag to OFF, i.e., stores a “0” in the temperature flag of the second storage buffer.

In S1310 the CPU 410 checks the second storage buffer in the sensing data storage area 4301 to determines whether two or more of the pressure flag, light flag, and temperature flag were set to ON in the above processes.

If at least two flags are set to ON (S1310: YES), then in S1311 the CPU 410 judges that the user is contacting the status communication terminal 401 and sets the contact flag to ON. However, if less than two flags are set to ON (S1310: NO), then in S1312 the CPU 410 judges that the user is not contacting the status communication terminal 401 and sets the contact flag to OFF. Specifically, the CPU 410 stores a “1” for the contact flag in the second storage buffer of the sensing data storage area 4301 when setting the contact flag to ON, and stores a “0” for the contact flag when setting the contact flag to OFF. After completing the process described above, the CPU 410 returns to the measurement process.

Next, the emotion data detection process executed during the main process will be described with reference to FIG. 44. In S1031 at the beginning of the emotion data detection process, the CPU 410 determines whether the infrared data, i.e., the heart rate stored in the second storage buffer, is less than 65. Since the emotion data detection process is executed after already determining in the process of FIG. 40 that the user is contacting the casing (S1005: YES), the acquired infrared data is used as the heart rate. If the heart rate is less than 65 (S103: YES), then in S1032 the CPU 410 determines whether a strong acceleration, such as an acceleration exceeding 1 G, was detected. If a strong acceleration was detected (S1032: YES), then in S1033 the CPU 410 sets the inferred status value to “5”. If the acceleration is not strong (S1032: NO), then in S1034 the CPU 410 sets the inferred status value to “6”.

However, if the heart rate is 65 or greater (S1031: NO), then in S1035 the CPU 410 determines whether the heart rate is less than 80. If the heart rate is less than 80 (S1035: YES), then in S1036 the CPU 410 sets the inferred status value to “7”. If the heart rate is 80 or greater (S1035: NO), then in S1037 the CPU 410 sets the inferred status value to “8”.

For example, if sensing data such as that shown in FIG. 36 is stored in the second storage buffer and the detected heart rate is 70, then the heart rate is greater than 65 (S1031: NO) but less than 80 (S1035: YES). Accordingly, the CPU 410 sets the inferred status value to “7”.

In S1038 the CPU 410 stores the inferred status value calculated in the above process as the inferred status value in the own terminal data storage area 4303 shown in FIG. 37. At this time, the CPU 410 also resets the update flag to “0” and subsequently returns to the main process.

Next, the ambient data detection process executed during the main process will be described with reference to FIG. 45. In S1061 at the beginning of the ambient data detection process, the CPU 410 determines whether peripheral movement was detected based on the infrared data saved in the second storage buffer. More specifically, the CPU 410 determines that peripheral movement occurred if the pulse count measured by the infrared sensor 414 exceeds a prescribed threshold, such as 45.

If peripheral movement has been detected (S1061: YES), then in S1062 the CPU 410 sets the inferred status value to “1”. However, if no peripheral movement was detected (S1061: NO), then in S1063 the CPU 410 determines whether ambient sound is less than 45 decibels (db). If the ambient sound is less than 45 db (S1063: YES), in S1064 the CPU 410 sets the inferred status value to “2”.

If the ambient sound exceeds 45 db (S1063: NO), then in S1065 the CPU 410 determines whether the ambient sound is less than 70 db. If ambient sound is less than 70 db (S1065: YES), then in S1066 the CPU 410 sets the inferred status value to “3”. If the ambient sound exceeds 70 db (S1065: NO), then in S1067 the CPU 410 sets the inferred status value to “4”.

In S1068 the CPU 410 stores the inferred status value calculated in the above process as the inferred status value in the own terminal data storage area 4303 shown in FIG. 37. At this time, the CPU 410 also resets the update flag to “0” and subsequently returns to the main process.

Next, the data transmission/reception process executed during the main process will be described with reference to FIG. 46. In S1041 at the beginning of the data transmission/reception process, the CPU 410 transmits data stored in the own terminal data storage area 4303 (see FIG. 37) to the intermediary server 402. Specifically, the CPU 410 transmits the terminal ID of the status communication terminal 401 itself, the terminal ID of a user whose status is to be displayed on the status communication terminal 401 itself, and the inferred status value of the status communication terminal 401 obtained in the emotion data detection process.

As will be described later, after receiving the terminal data, the intermediary server 402 transmits data for all terminals, i.e., data for all status communication terminals 401 stored in the intermediary server 402. Accordingly, in S1042 the status communication terminal 401 receives this transmitted data for all terminals. In S1043 the status communication terminal 401 stores the content of the received data in the all terminal data storage area 4304, updating the data therein, and subsequently returns to the main process. Through the above process, data for other status communication terminals 401 registered in the intermediary server 402 is transmitted altogether at the timing that the status communication terminal 401 transmits its own inferred status value to the intermediary server 402, enabling the status communication terminal 401 to store inferred status values for all status communication terminals 401.

Next, the specified terminal status display process executed during the main process will be described with reference to FIG. 47. In S1051 at the beginning of this process, the CPU 410 determines whether an ID number for the specified terminal has been stored in the own terminal data storage area 4303 (see FIG. 37), i.e., whether the ID of a terminal for which status is to be displayed has been specified. As described earlier, when the identification member 452 is mounted in the mounting part 455, the photosensor 418 reads the specified terminal ID from the identification member 452, and the CPU 410 stores the value outputted from the photosensor 418 as the specified terminal ID of the own terminal data storage area 4303.

If a terminal has not been specified (S1051: NO), then the CPU 410 simply returns to the main process since there exists no status to be displayed.

However, if a specified terminal ID is stored in the own terminal data storage area 4303 (S1051: YES), then in S1052 the CPU 410 retrieves the specified terminal ID from the data stored in the all terminal data storage area 4304.

In S1053 the CPU 410 determines whether the specified terminal ID in the specified terminal data retrieved as a result of the search is the ID of the status communication terminal 401 itself, i.e., whether the two terminals are specifying each other. For example, if its own terminal ID is A and the ID of the terminal specified by its own terminal is B, then the CPU 410 determines whether the specified terminal ID for terminal B retrieved from the all terminal data storage area 4304 is A. If the specified terminal ID stored with the specified terminal in the all terminal data storage area 4304 is not the ID number for the status communication terminal 401 itself (S1053: NO), the CPU 410 advances to S1055.

However, if the specified terminal ID is the ID for the status communication terminal 401 itself (S1053: YES), then in S1054 the CPU 410 renders a special display indicating that the two terminals have designated each other (a “reciprocal display” in the preferred embodiment). The reciprocal display may be implemented according to a variety of methods, such as lighting a special LED, or flashing the normal LED.

After performing the reciprocal display in S1054, or if the reciprocal display was not performed (S1053: NO), in S1055 the CPU 410 determines whether the data for the specified terminal found in S1052 includes an inferred status value. If an inferred status value is not stored for the specified terminal (no data; S1055: NO), then the CPU 410 simply returns to the main process, since a status cannot be displayed.

However, if an inferred status value is stored for the specified terminal (S1055: YES), then in S1056 the CPU 410 activates the LED 421, motor 423, or other actuators to display the status based on this inferred status value and with reference to the status display table stored in the status display table storage area 4305 (see FIG. 39), and subsequently returns to the main process. For example, if the inferred status value is “2”, then the CPU 410 flashes the LED 421 once in blue over two seconds. The status for the specified terminal is displayed in the upper half of the status communication terminal 401.

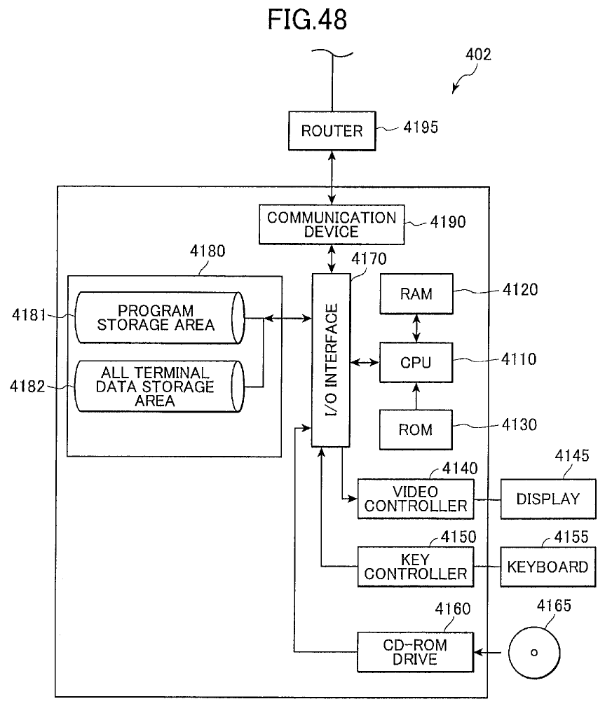

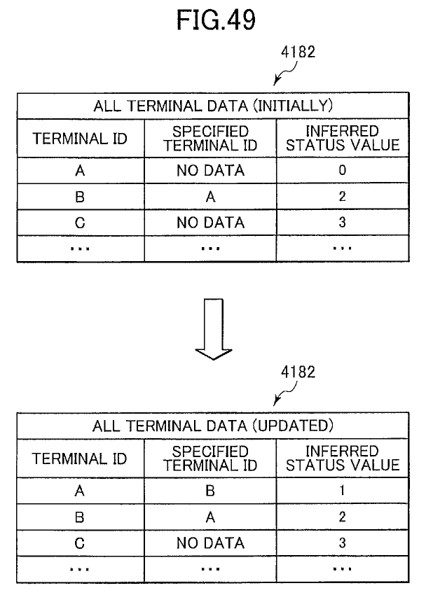

Next, the structure and operations of the intermediary server 402 constituting the status communication system 1000 will be described with reference to FIGS. 48-50. First, the structure of the intermediary server 402 will be described with reference to FIGS. 48 and 49. FIG. 48 is a block diagram showing the electrical structure of the intermediary server 402. FIG. 49 is an explanatory diagram conceptually illustrating the structure of an all terminal data storage area 4182.

The intermediary server 402 is configured of a common computer having a communication device 4190 for connecting to the internet 404 via a router 4195.

As shown in FIG. 48, the intermediary server 402 is provided with a CPU 4110 for controlling the intermediary server 402. The CPU 4110 is connected to a RAM 4120 for temporarily storing various data, a ROM 4130 for storing a BIOS and the like, and an I/O interface 4170 for mediating the exchange of data. The I/O interface 4170 is also connected to a hard disk drive 4180. The hard disk drive 4180 includes a program storage area 4181, an all terminal data storage area 4182 for storing terminal data transmitted from each status communication terminal 401, and other data storage areas (not shown). The program storage area 4181 stores programs executed by the CPU 4110.

The I/O interface 4170 is also connected to a video controller 4140, a key controller 4150, a CD-ROM drive 4160, and the communication device 4190. The video controller 4140 is connected to a display 4145. The key controller 4150 is connected to a keyboard 4155. The communication device 4190 can connect to the internet 404 via the router 4195. A CD-ROM 4165 inserted in the CD-ROM drive 4160 stores control programs for the intermediary server 402. When the CD-ROM 4165 is inserted in the CD-ROM drive 4160, the control programs are installed from the CD-ROM 4165 into the hard disk drive 4180 and stored in the program storage area 4181.

Next, the all terminal data storage area 4182 of the hard disk drive 4180 will be described with reference to FIG. 49. The all terminal data storage area 4182 stores terminal IDs, specified terminal IDs, and inferred status values transferred to the intermediary server 402 from each status communication terminal 401. When new data is transferred from one of the status communication terminals 401, the specified terminal ID and inferred status value of the status communication terminal 401 corresponding to the terminal ID is overwritten with the new data, thus updating the corresponding record among all terminal data. With regard to the status communication terminals 401 having IDs A, B, C, etc. in the all terminal data storage area 4182 shown in the top of FIG. 49, for example, prior to updating, terminal A has “no data” for the specified terminal and “0” as the inferred status value; terminal B has “A” as the specified terminal and “2” as the inferred status value; and terminal C has “no data” as the specified terminal and “3” as the inferred status value. At this time, data is transmitted from terminal A and the data for terminal A is updated, as shown in the bottom of FIG. 49. Hence, terminal A has “B” as the specified terminal and “1” as the inferred status value; terminal B has “A” as the specified terminal and “2” as the inferred status value; and terminal C has “no data” as the specified terminal and “3” as the inferred status value.

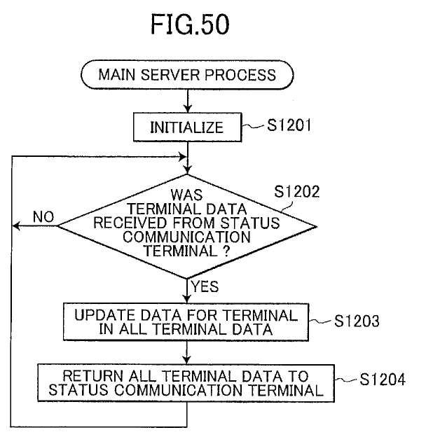

Next, the operations of the intermediary server 402 will be described with reference to FIG. 50. FIG. 50 is a flowchart illustrating steps in a main process performed on the intermediary server 402. The main process begins when the power to the intermediary server 402 is turned on. After performing initialization in S1201, in S1202 the CPU 4110 determines whether data has been received from any of the status communication terminals 401. If data has not been received (S1202: NO), then the CPU 4110 continually loops back to S1202 to wait for data. When data is received (S1202: YES), then in S1203 the CPU 4110 receives the terminal data (see FIG. 37) and updates the record corresponding to the terminal in the all terminal data storage area 4182. For example, if the content of the all terminal data storage area 4182 is that shown in the top of FIG. 49, and terminal data having the content shown in FIG. 37 is received from a status communication terminal 401 having the terminal ID “A”, then the CPU 4110 updates the data record corresponding to terminal A to reflect the content as shown in the bottom of FIG. 49.

In S1204 the CPU 4110 transmits data for all terminals stored in the updated all terminal data storage area 4182 to the status communication terminal 401 that was the source of received data in S1202 (terminal A in the above example), and subsequently returns to S1202. Hence, a status communication terminal 401 that transmits terminal data can obtain terminal data for other status communication terminals 401 from the intermediary server 402 in return. As described above, the status communication terminal 401 can subsequently extract specified terminal data from the received data for all terminals and display the status of the specified terminal through actuators.

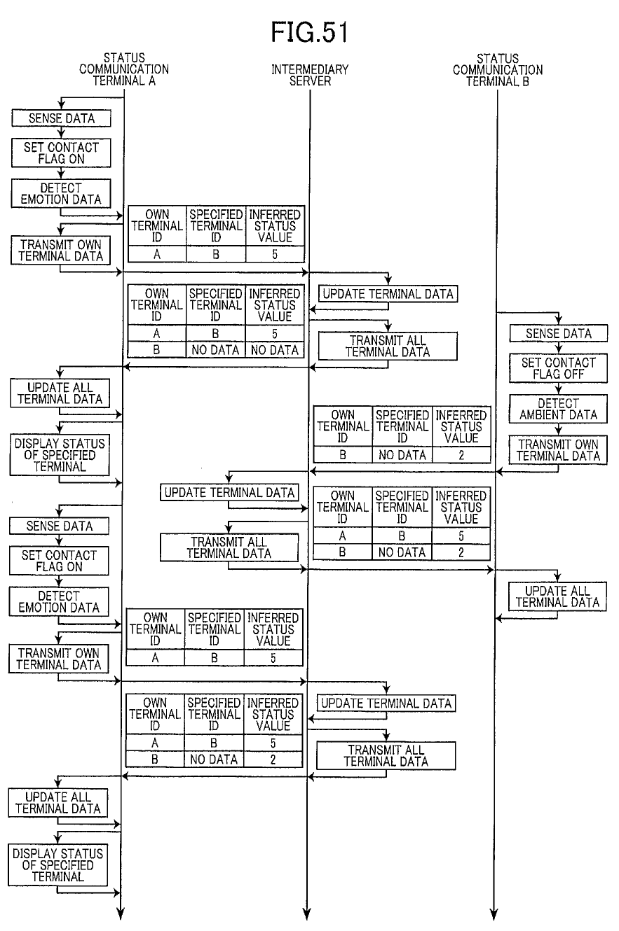

Next, the overall process performed on the status communication system 1000 will be described with reference to the time chart in FIG. 51 when the plurality of status communication terminals 401 and the intermediary server 402 constituting the status communication system 1000 execute the processes described above. FIG. 51 is a time chart for the status communication system 1000. In the following example, a process is performed among a status communication terminal A having a terminal ID of “A” with an identification member 452 specifying a terminal ID “B” as the communication destination mounted in the mounting part 455; a status communication terminal B having a terminal ID of “B” with no identification member 452 mounted in the mounting part 455; and the intermediary server 402. Further, status communication terminal A is gripped by its user, while status communication terminal B is resting on a desk and not held by its user. The following process will be described while referring to the flowcharts in FIGS. 40-47 and 50 when necessary.

In the example shown in FIG. 51, status communication terminal A first initiates the ID recognition process (S1002 of FIG. 40) and subsequently initiates the measurement process (S1003 of FIG. 40). When gathering sensing data in the measurement process (FIG. 42), terminal A sets the contact flag to ON based on the acquired sensing data in this example. Therefore, terminal A executes the emotion data detection process (S1006 of FIG. 40) and obtains an inferred status value (“5” in this example). While not indicated in the time chart, terminal A obtains the ID “B” from the identification member 452 in the ID recognition process as the specified terminal. Terminal A stores the inferred status value and the specified terminal ID in the own terminal data storage area 4303 and transfers this data to the intermediary server 402 (S1009 of FIG. 40) as its own terminal data (see FIG. 37). In this example, the own terminal data transferred from status communication terminal A to the intermediary server 402 is “own terminal ID: A, specified terminal ID: B, inferred status value: 5.”

The intermediary server 402 receives the own terminal data from terminal A and updates the corresponding record in the all terminal data storage area 4182 (S1203 of FIG. 50). Subsequently, the intermediary server 402 transmits all data stored in the all terminal data storage area 4182 to status communication terminal A (S1204 of FIG. 50). In this example, terminal data for status communication terminals A and B is stored in the all terminal data storage area 4182. The data for terminal A has been updated to “own terminal ID: A, specified terminal ID: B, inferred status value: 5,” while the data for terminal B in this example is “own terminal ID: B, specified terminal ID: no data, inferred status value: no data.” Hence, the intermediary server 402 transmits data for these two records to terminal A. While the intermediary server 402 statically stores IDs for all status communication terminals in advance, as a variation the intermediary server 402 may dynamically store only IDs of status communication terminals connected to the intermediary server 402, that is, IDs of status communication terminals that have transmitted terminal data.

In the meantime, while the intermediary server 402 is transmitting data for all terminals to terminal A, in this example status communication terminal B initiates the ID recognition process (S1002 of FIG. 40) and subsequently initiates the measurement process (S1003 of FIG. 40). When sensing data is gathered in the measurement process (FIG. 42), terminal B sets the contact flag to OFF based on the acquired sensing data in this example. Accordingly, terminal B executes the ambient data detection process (S1007 of FIG. 40) and obtains an inferred status value of “2” in this example. While not shown in the drawing, terminal B did not acquire a specified terminal ID in the ID recognition process because the identification member 452 is not inserted. Therefore, terminal B stores only the own terminal ID and inferred status value in the own terminal data storage area 4303 and sets the specified terminal ID to “no data.” Subsequently, terminal B transmits values stored in the own terminal data storage area 4303 to the intermediary server 402 as own terminal data (S1009 of FIG. 40). The own terminal data transmitted from the status communication terminal B to the intermediary server 402 in this example is “own terminal ID: B, specified terminal ID: no data, inferred status value: 2.”

The intermediary server 402 receives this own terminal data from terminal B and updates the corresponding record in the all terminal data storage area 4182 (S1203 of FIG. 50). Subsequently, the intermediary server 402 transmits all data stored in the all terminal data storage area 4182 to status communication terminal B (S1204 of FIG. 50). In this example, terminal data for status communication terminals A and B are stored in the all terminal data storage area 4182, and the data for terminal A is “own terminal ID: A, specified terminal ID: B, inferred status value: 5,” while the data for terminal B has been updated to “own terminal ID: B, specified terminal ID: no data, inferred status value: 2.” The intermediary server 402 transmits data for these two records to terminal B.

Status communication terminal A updates the contents of the all terminal data storage area 4304 in the RAM 430 based on all terminal data previously transmitted from the intermediary server 402 (S1043 of FIG. 46). In other words, terminal A copies the data for all terminals “own terminal ID: A, specified terminal ID: B, inferred status value: 5” and “own terminal ID: B, specified terminal ID: no data, inferred status value: no data” transmitted from the intermediary server 402 to the all terminal data storage area 4304 (see FIG. 37).

Further, since the user of terminal A wishes to display the status of terminal B, terminal A retrieves data for terminal B from the all terminal data storage area 4304 (S1052 of FIG. 47) in order to display the status of terminal B (S1010 of FIG. 40). However, since an inferred status value is not stored in the all terminal data storage area 4304 for terminal B (S1055: NO in FIG. 47), terminal A does not display a status in the upper section of the terminal since the status is unknown.

Similarly, terminal B updates the contents of the all terminal data storage area 4304 in the RAM 430 based on all terminal data transmitted from the intermediary server 402 (S1043 of FIG. 46). In other words, terminal B copies data for all terminals “own terminal ID: A, specified terminal ID: B, inferred status value: 5” and “own terminal ID: B, specified terminal ID: no data, inferred status value: 2” transmitted from the intermediary server 402 to the all terminal data storage area 4304.

Since the user of terminal B has not specified a status communication terminal for which a status is to be displayed in this example (S1051: NO in FIG. 47), terminal B does not display a status in the upper section of the terminal.

As terminal A repeats the main process in FIG. 40, terminal A sets the contact flag to ON based on the new sensing data. After executing the emotion data detection process (S1006 of FIG. 40), terminal A again transmits this inferred status value to the intermediary server 402 (S1009 of FIG. 40) as own terminal data (see FIG. 37). At this time, the own terminal data transmitted from terminal A to the intermediary server 402 is still “own terminal ID: A, specified terminal ID: B, inferred status value: 5.”

The intermediary server 402 receives this own terminal data from terminal A and updates the corresponding record in the all terminal data storage area 4182 (S1203 of FIG. 50). Subsequently, the intermediary server 402 transmits all data stored in the all terminal data storage area 4182 to terminal A (S1204 of FIG. 50). The record corresponding to terminal B has previously been updated in the all terminal data storage area 4182 based on the data transmitted from terminal B. Hence, the current content in the all terminal data storage area 4182 is “own terminal ID: A, specified terminal ID: B, inferred status value: 5” and “own terminal ID: B, specified terminal ID: no data, inferred status value: 2.” This data is transmitted to terminal A.

Subsequently, terminal A updates the contents of the all terminal data storage area 4304 in the RAM 430 based on all terminal data transmitted from the intermediary server 402 (S1043 of FIG. 46). In other words, terminal A copies the data for all terminals “own terminal ID: A, specified terminal ID: B, inferred status value: 5” and “own terminal ID: B, specified terminal ID: no data, inferred status value: 2” transmitted from the intermediary server 402 to the all terminal data storage area 4304.

Since the user of terminal A has specified terminal B as the terminal for which a status is to be displayed, terminal A retrieves data for terminal B from the all terminal data storage area 4304 (S1052 of FIG. 47) in order to display the status for terminal B (S1010 of FIG. 40). Since the inferred status value for terminal B is now included in the all terminal data (S1055: YES in FIG. 47), terminal A displays the status for terminal B in the upper section of the terminal (S1056 of FIG. 47). More specifically, since the inferred status value for terminal B is “2”, terminal A flashes the LED 421 in blue in the upper section of the terminal over a two-second period based on the status display table storage area 4305 (see FIG. 39). Further, since the inferred status value for terminal A is “5”, the LED 421 is already displaying yellow in the lower section of the terminal according to the own terminal status display process (S1008 of FIG. 40).

As described above, the status communication system 1000 of the preferred embodiment determines whether the user is touching the status communication terminal 401 based on sensing data from the pressure sensor 416, optical sensor 415, and temperature sensor 413 of the status communication terminal 401 and calculates an inferred status value by executing the emotion data detection process based on this sensing data when the user is contacting the status communication terminal 401, and executing the ambient data detection process when the user is not contacting the status communication terminal 401. The status communication terminal 401 displays its own status using the LED 421 and motor 423 based on the calculated inferred status value. Further, the identification member 452 is inserted into the mounting part 455 to indicate another terminal with which the user wishes to communicate. In this case, the status communication terminal 401 acquires the ID of the specified terminal using the photosensor 418 and subsequently transmits the inferred status value calculated above together with the acquired specified terminal ID to the intermediary server 402 as own terminal data. Upon receiving the terminal data, the intermediary server 402 updates the record corresponding to the terminal in the all terminal data storage area 4182 and returns all terminal data to the status communication terminal 401 from which terminal data was received. Upon receiving all terminal data, the status communication terminal 401 stores this data in the all terminal data storage area 4304 of the RAM 430, searches for terminal data for the other status communication terminal 401 specified by the specified terminal data and, if found, renders the status of the other terminal in the upper section of the status communication terminal 401 using the LED 421 and motor 423 based on the inferred status value. In this way, the user of the status communication terminal 401 can learn the ambient state of the status communication terminal 401 to which the user wishes to communicate when the user of the other status communication terminal 401 is not touching the terminal.

While the invention has been described in detail with reference to specific embodiments thereof, it would be apparent to those skilled in the art that many modifications and variations may be made therein without departing from the spirit of the invention, the scope of which is defined by the attached claims.

For example, while the status collection terminal 100 transmits second status data to the first status communication terminal 1 in the first embodiment described above, the status collection terminal 100 may simply transmit second status data to the server 3 without returning the second status data to the first status communication terminal 1.

Since the second status data received from the status collection terminal 100 is stored on the server 3, the user of another terminal (personal computer or the like) capable of accessing the server 3 can use this terminal to learn the states of all users of the first status communication terminal 1 for which second status data has been transmitted.

Further, while the status collection terminal 100A in the first embodiment receives from the server 3 first status data calculated by the second status communication terminal 2, which is another terminal that can communicate with the server 3, or second status data calculated by the status collection terminal 100B. But the status collection terminal 100 may be configured not to receive status data from the server 3 but simply to transmit data to the server 3.

Further, while the status collection terminal 100 in the first embodiment calculates the third status data, the status collection terminal 100 may be configured not to calculate the third status data but only to receive first status data, second status data, or the like from the server 3 calculated on other terminals that can communicate with the server 3.

Further, while the status collection terminal 100 of the first embodiment transmits the third status data to the first status communication terminals 1 within wireless communication range of the status collection terminal 100, the status collection terminal 100 may be configured not to transmit third status data to first status communication terminals 1 existing in wireless communication range but simply to control the display on the display unit 107 based on the third status data.

Further, while the status collection terminal 100 of the first embodiment includes the slot 115 in which the ID card 116 is inserted and the ID infrared sensor 112 and receives all data from the server 3 including data for a terminal ID specified on the ID card 116, the status collection terminal 100 may instead receive only data for the terminal ID specified on the ID card 116.

Further, while the status collection terminal 100 according to the first embodiment includes the display unit 107 and controls the display on the display unit 107 based on the first status data, second status data, third status data, and the like, the status collection terminal 100 may not be provided with the display unit 107 and may simply exchange various data among the first status communication terminals 1 and the server 3.

Further, while the status collection terminal 100 according to the first embodiment renders the status of each user by varying the color displayed on the display unit 107, the status collection terminal 100 may render the status of each user by displaying an illustration or video on the display unit 107 corresponding to each status.

Further, while the status collection terminal 100 according to the first embodiment controls which user's status is displayed on the display unit 107 based on a number of inputs received by the membrane switch 113 in S507 of the display unit control process, the status collection terminal 100 may control which user's status is displayed on the display unit 107 by automatically switching the status at specified intervals. For example, the status collection terminal 100 may switch the display on the display unit 107 every five seconds.

Further, the status collection terminal 100 according to the first embodiment controls which user's status is displayed on the display unit 107 based on the number of inputs received by the membrane switch 113 in S507 of the display unit control process, but the status collection terminal 100 may instead switch the display on the display unit 107 each time a single input is received in the membrane switch 113.

Further, while each of the first status communication terminals 1 and second status communication terminals 2 in the first embodiment infers the state of the user based on measured values from the heart rate sensor 16, body temperature sensor 17, and perspiration sensor 18, other sensors may also be used to infer the status of the user.

Further, while each of the first status communication terminals 1 and second status communication terminals 2 of the first embodiment infers the state of the user based on measured values from the heart rate sensor 16, body temperature sensor 17, and perspiration sensor 18, the terminals may infer the status of the peripheral environment for each terminal using sensors measuring ambient data for the user. The status communication terminals 401 according to the second embodiment may also be used in the first embodiment for inferring the ambient status of each terminal.

Further, while the data that the status collection terminal 100 according to the first embodiment displays on the display unit 107 in the display unit control process (S74 of FIG. 17, and FIG. 21) is identical to the data transmitted via the transceiver 109, the data displayed on the display unit 107 may be different from the data transmitted via the transceiver 109. For example, the status collection terminal 100 may control the display on the display unit 107 based on the second status data and may transmit the third status data via the transceiver 109.

Further, the status collection terminal 100 calculates the second status data in S276 of FIG. 18 by totaling the values for all first status data stored in the collected data storage area 301, dividing this sum by the number of first status communication terminals for which first status data was collected, and rounding off the obtained average value, but the present invention is not limited to this method.

For example, the status collection terminal 100 may calculate the second status data by counting each status type indicated by first status data received in a prescribed interval (ten seconds, for example) and setting the status with the largest count as the second status data.

The status collection terminal 100 may also calculate the second status data by assigning stepped level values as weights to the types of states, calculating an average value by multiplying the number of each state by its level value, and setting the second status data to the status for which the product of the count and level value is closest to the average value.

The status collection terminal 100 may also calculate the second status data by assigning level values to each type of status and setting the second status data to the status having the highest level value.

The status collection terminal 100 may also calculate the second status data by assigning weighting coefficients to each type of status and setting the second status data to the status obtaining the largest value when multiplying its count by its weighting coefficient.

The status collection terminal 100 may also set the second status data to the status indicated by the first status data initially received in a prescribed interval (ten seconds, for example).

The status collection terminal 100 may also set the second status data to the status indicated by the first status data last received from the first status communication terminal 1 transmitting the largest number of first status data in a prescribed interval (ten seconds, for example).

The status collection terminal 100 may also set the second status data to the status indicated by the first status data last received from the first status communication terminal 1 transmitting first status data at the shortest interval.

Further, while the status collection terminal 100 according to the first embodiment calculates the third status data in S514 of FIG. 21 by adding the value of its own status value to the status value for the ID number stored in the specified ID storage area 305 and dividing this sum by 2, but the present invention is not limited to this method.

For example, the status collection terminal 100 may calculate the third status data according to the following method. In this method, the status collection terminal 100 acquires a total number of users of first status communication terminals 1 each time first status data is collected from the first status communication terminals 1. The status collection terminal 100 then includes this total when transmitting data to the server 3, and the server 3 stores the total along with the ID numbers and status values.

Hence, when calculating the third status data, the status collection terminal 100 initially finds a first number by adding the product of its own status value and the total number of its users, and the product of the status for the specified ID number and the total users of the terminal having the specified ID number. Next, the status collection terminal 100 finds a second number by adding the total number of its own users to the total number of users for the specified terminal. Next, the status collection terminal 100 sets the third status data to a value obtained by dividing the first number by the second number and then rounding off.

Further, while terminal data is transmitted via the intermediary server 402 in the second embodiment, the status communication terminals 401 may be connected to and exchange data among each other, without going through the intermediary server 402.

Further, the casing of the status communication terminal 401 is not limited to a spherical shape, provided that the size of the casing is suitable for the user to grip.

Further, while an infrared sensor is used as a motion detection sensor in the preferred embodiment, the status communication terminal 401 switches between a motion detection sensor for cases in which the user is not touching the casing, and a heart rate sensor for cases in which the user is touching the casing. However, another motion detection sensor may also be used in place of the infrared sensor for detecting peripheral motion.

What is claimed is:

1. A status communication system comprising:
a plurality of first status communication terminals;
a status collection terminal that communicates with the plurality of first status communication terminals; and
a server that communicates with the status collection terminal via a network,
wherein each of the plurality of the first status communication terminals comprises:
at lease one measuring unit that measures biological data on a user and data on a user's peripheral environment;
a first calculating unit that calculates first status data indicating one of status of the user and status of the peripheral environment based on measurement data measured by the measuring unit; and
a first transmitting unit that transmits the first status data calculated by the first calculating unit,
wherein the status collection terminal comprises:
a first collecting unit that collects the first status data transmitted from the first transmitting unit of at least one of the first status communication terminals;
a second calculating unit that calculates second status data by consolidating the first status data collected by the first collecting unit under a prescribed condition; and
a second transmitting unit that transmits the second status data calculated by the second calculating unit,
wherein the server comprises:
a receiving unit that receives the second status data transmitted from the second transmitting unit of the status collection terminal; and
a storing unit that stores the second status data received by the receiving unit.

2. A status communication method performed in a status communication system comprising a plurality of first status communication terminals, a status collection terminal that communicates with the plurality of first status communication terminals, and a server that communicates with the status collection terminal via a network, the status communication method comprising:
on the first status communication terminal,
measuring one of biological data on a user and data on a user's peripheral environment;
calculating first status data indicating one of the status of the user and the status of the peripheral environment based on measurement data measured in the measuring step; and
transmitting the first status data calculated in the calculating step;
on the status collection terminal,
collecting the first status data transmitted in the transmitting step on the first status communication terminal performed by at least one first status communication terminal;
calculating second status data obtained by consolidating the first status data collected in the collecting step under a prescribed condition; and
transmitting the second status data calculated in the calculating step on the status collection terminal; and
on the server,
receiving the second status data transmitted in the transmitting step on the status collection terminal performed on the status collection terminal; and
storing the second status data received in the receiving step.

3. A status collection terminal capable of communicating with a plurality of first status communication terminals that measures one of biological data on a user and data on a user's peripheral environment, calculates first status data indicating one of the status of the user and the user's peripheral environment based on the measurement data, and transmits the first status data to the status collection terminal, and capable of communicating with a server via a network, the status collection terminal comprising:
a first collecting unit that collects the first status data transmitted from at least one of the first status communication terminals;
a second calculating unit that calculates second status data by consolidating the first status data collected by the first collecting unit under a prescribed condition; and
a second transmitting unit that transmits the second status data calculated by the second calculating unit to the server.

4. The status collection terminal according to claim 3, further comprising a third transmitting unit that transmits the second status data calculated by the second calculating unit to the first status communication terminal.

5. The status collection terminal according to claim 3, further comprising a second collecting unit that collects one of third status data calculated by a second status communication terminal and fourth status data calculated by another status collection terminal from the server, the second status communication terminal measuring one of biological data on a user and data on a users' peripheral environment and calculating the third status data based on the one of the biological data on the user and data on the users' peripheral environment, the another status collection terminal calculating the fourth status data based on fifth status data calculated by a plurality of third status communication terminals that measures one of biological data on the user and the user's peripheral environment,
wherein the server communicates with the second status communication terminal and the another status collection terminal via a network, and stores at least one of the third status data calculated by the second status communication terminal and the fourth status data calculated by the another status collection terminal.

6. The status collection terminal according to claim 5, further comprising a third calculating unit that calculates sixth status data by consolidating the second status data calculated by the second calculating unit, and one of the third status data and the fourth status data collected by the second collecting unit according to a prescribed condition.

7. The status collection terminal according to claim 6, further comprising a fourth transmitting unit that transmits one of the third status data and the fourth status data collected by the second collecting unit and the sixth status data to the first status communication terminals.

8. The status collection terminal according to claim 5, further comprising a specifying unit that specifies one of the third status data and the fourth status data collected by the second collecting unit, the second collecting unit collecting data including at least one of the third status data and the fourth status data specified by the specifying unit.

9. The status collection terminal according to claim 3, further comprising:
a display unit that displays desired images; and
a display control unit that controls a display on the display unit based on the second status data calculated by the second calculating unit.

10. The status collection terminal according to claim 5, further comprising:
a display unit that displays desired images; and
a display control unit that controls a display on the display unit based on one of the third status data and the fourth status data collected by the second collecting unit.

11. The status collection terminal according to claim 6, further comprising:
a display unit that displays desired images; and
a display control unit that controls a display on the display unit based on the sixth status data calculated by the third calculating unit.

12. The status collection terminal according to claim 5, further comprising:
a display unit that displays desired images and comprises a first display region and a second display region separate from the first display region; and
a display control unit that controls a display in the first display region based on the second status data calculated by the second calculating unit, and that controls a display in the second display region based on one of the third status data or the fourth status data collected by the second collecting unit.

13. A storage medium storing a status collection program readable by a computer, the status collection program that controls a status collection terminal capable of communicating with a plurality of first status communication terminals that measures one of biological data on a user and data on the user's peripheral environment, calculates first status data indicating one of the status of the user and a user's peripheral environment based on the measurement data, and transmits the first status data to the status collection terminal, and capable of communicating with a server via a network, the status collection program comprising:
instructions for collecting the first status data transmitted from at least one of the first status communication terminals;
instructions for calculating second status data by consolidating the first status data collected by the first collecting unit under a prescribed condition; and
instructions for transmitting the second status data calculated by the second calculating unit to the server.
